(19) United States
(12) Patent Application Publication
(10) Pub. No.: US 2009/0022970 A1
(43) Pub. Date: Jan. 22, 2009

(54) Polymer Film and Solution Casting Method for Producing Thereof

(75) Inventor: Hiroshi Miyachi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/886,920

(22) PCT Filed: Jan. 24, 2006
(86) PCT No.: PCT/JP2006/301391

§ 371 Date: Sep. 21, 2007

(30) Foreign Application Priority Data
Mar. 22, 2005 (JP) 2005-081219

(51) Int. Cl. B32B 5/00; C08B 3/06; B29C 55/00

(52) U.S. Cl. 428/220; 536/63; 264/291

(57) ABSTRACT

A dope containing TAC is cast onto a belt. When having self-supporting properties, the dope is peeled as a wet film (46) from the belt, and transported into a tenter dryer (60). A preheating is made in an entrance section (80), and a stretching is made in a stretching section (81). In a relaxation section (82), the width of the film was becomes shorter, and in the exit section (83), the width was kept to be uniform and transported from the tenter dryer (60) as a film (61). When a width of the wet film (46) right before the stretching is L1 (mm), a maximum width of the wet film (46) in the stretching is L2 (mm) and a width of the wet film (46) right after the relaxation is L3 (mm), the stretching and relaxation are performed so as to satisfy a following formula,

3<(L2−L3)/L1×100<9

### TECHNICAL FIELD

The present invention relates to a polymer film and a solution casting method for producing the polymer film.

### BACKGROUND ART

A polymer is used in several manners. For example, a film is produced from cellulose acylate (hereinafter TAC) and used as a base film of a photosensitive material or a protective film for a polarizing filter in a liquid crystal display (LCD). As already known methods for producing the polymer film, there are a melt-extrusion method in which the polymer is melt with heating and an extrusion thereof is made to obtain the film, and a solution casting method in which a dope containing the polymer, a solvent and the like is prepared and the casting of the dope is made to obtain the film. The film obtained in the solution casting method is excellent in an optical isotropy and therefore used as an optical film (Japan Institute of Invention and Innovation (JIII) JOURNAL of Publication No. 2001-1745).

The LCD is generally used for a personal computer, a monitor of a mobile device and a television in view of several merits, such as low voltage, low electric power requirement, miniaturization and thinner shape. There are several modes of such LCD corresponding to arrangement of liquid crystal molecules in a liquid crystal cell. In the prior art, a TN mode is popular, in which the liquid crystal molecules are twisted at about 90° to lower and upper bases.

Usually, the liquid crystal display is constructed of the liquid crystal cell, an optical compensation sheet and a polarizer. The optical compensation sheet is used for reducing the coloring of an image or widening a view angle. In order to obtain the optical compensation sheet, a transparent film or a birefringence film after the stretching is coated with a liquid crystal material. For example, as described in Japanese Patent No. 2587398, a triacetylcellulose film is coated with a discotic liquid crystal material to obtain an optical compensation sheet in which orientations of liquid crystal molecules are fixed, and the optical compensation sheet is used with the liquid crystal cell of the TN mode. Thus the view angle becomes wider. Further when the liquid crystal display is used for the TV monitor, viewers watches the TV monitor in several directions. Therefore, it is required that the view angle should be wider. However, the requirement is hardly satisfied in the above liquid crystal display and a method of producing thereof. Accordingly, the search of the liquid crystal display is made for IPS (In-Plane Switching) mode, OCB (Optionally Compensatory Bend) mode, VA (Vertically Aligned) mode and the like that are different from the TN mode. Especially the VA mode attracts attentions for using as the TV monitor, since having a high contrast and a lower process yield.

Otherwise, the optical compensation sheet (or a retardation film) of the liquid crystal display is required to have optical anisotropy (high retardation value). Especially, in the optical compensation sheet for the VA mode LCD, it is necessary that the in-plane retardation (Re) is from 30 nm to 200 nm and the thickness retardation (Rth) is from 70 nm to 400 nm. Therefore, as the optical compensation sheet, a synthetic polymer film whose retardation value is high is used, for example a polycarbonate film, a polysulfone film and the like.

As described above, usually in a technical field of the optical materials, the synthetic polymer film is used when the optical anisotropy (high retardation value) is required, and the TAC film is used when the optical isotropy (low retardation) is required.

However, the International Patent Publication No. 0055657 teaches a TAC film which has a high retardation value enough for the use in case of the requirement of the optical anisotropy. In order to provide the high retardation value for the TAC film, aromatic compounds having at least two aromatic rings, especially 1,3,5-triazine rings, are contained in the film, and the stretching of the film is made.

Usually, the TAC film is hardly stretched, and therefore it is difficult to increase the birefringence. However, when additives are oriented simultaneously by the stretching, the birefringence increases and the retardation value becomes high. In this case, since the TAC film also has a function of a protective film for a polarizing filter, the low-cost and thin liquid crystal display can be supplied in the market.

Japanese Patent Laid-Open Publication No. 2002-7195 teaches an optical film containing cellulose esters which has acyl groups having 2-4 carbon atoms. This cellulose esters simultaneously satisfy following formulae, if the acetylation degree is A and the degree of substitution of propionyl group or butylyl group is B: 2.0≦A+B≦3.0 and A<2.4. Further, a refractive index Nx of wave at 590 nm wavelength along a slow axis and a refractive index Ny of wave along a fast axis satisfy a formula 0.0005≦Nx−Ny≦0.0050. Further, Japanese Patent Laid-Open Publication No. 2002-270442 teaches a polarizing filter used for the VA mode liquid crystal display. This polarizing filter includes a polarizer and an optically biaxial film formed from cellulose esters of mixed aliphatic acids.

In a solution casting method, a dope is cast onto a support to form a casting film. Then the casting film is peeled as a film when having a self-supporting property. The film is transported to a tenter dryer and dried therein with stretching in a widthwise direction. Thereafter the drying is further made, the edge portions are slit off, and the film is wound up. The film is adhered onto a polarizer so that the polarizing filter is obtained.

When the retardation film is adhered to the polarized film, it is preferable that a direction of the slow axis of the retardation film is a crosswise direction of the polarized film. The stretching of the retardation film is preferably made in the widthwise direction thereof. In view of the uniformity and smoothness and the like, the film produced by the solution casting method is preferable. Further, for increasing of the productivity, the stretching is preferably made in a film production line. In the stretching in the widthwise direction by the tenter dryer, a bowing phenomenon occurs, and therefore the direction of the slow axis is different from the widthwise direction. A research of such phenomena is progressive in the biaxial stretching of the polyester film, and the biaxial stretching of the polyester film produced by the melt-extrusion method is searched. Thus several methods of improvements are proposed.

However, in the melt-extrusion method for producing the polyester film, a bowing phenomenon occurs by the stretching, and therefore middle part may be backward to side edge parts of the continuous film. In contrast, about the bowing phenomenon of the solution casting method for producing the TAC film, the middle part may be frontward to the edge parts of the continuous film. Therefore, the method for preventing the bowing in the polyester film cannot be applied to the method for producing the TAC film. In considering this problem, Japanese Patent Laid-Open Publication No. 2002-296422 teaches following methods of reducing the bowing phenomenon in the TAC film during the stretch of the film containing a solvent:
1) using cellulose ester having predetermined degree of substitution;
2) making the temperature in side edge portions of the film higher than a middle portion;
3) making the content of the solvent in the side edge portions larger than the middle portion;
4) sectioning the tenter dryer into plural sections whose temperatures are different.

The methods of the publications No. 2002-7195 & 2002-270442 have merits in view that the thin LCD of low cost can be produced. However, in recent years, it is required to increase the retardation value moreover. Therefore it is necessary that the amount of a retardation controller to be added is made larger and the stretch ratio is increased. However, it increases the extent of the bowing phenomenon caused by the stretching.

The method described in the publication 2002-296422 has large efficiencies. However, since the contrast ratio and the brightness of the LCD are increased in the recent years, it is required moreover to prevent that the direction of the slow axis of the optical film becomes different from the widthwise direction of the film. Therefore, it is too hard to satisfy this requirement only by the above methods. Further, if different heating sections in the tenter dryer or the accurate temperature control in the widthwise direction of the film is provided, the number of the heating devices and the controlling devices becomes larger. Thus the structure becomes complicated, and the cost for the equipment becomes higher.

An object of the present invention is to provide a polymer film in which a misalignment of a slow axis from a widthwise direction of the film is reduced.

Another object of the present invention is to provide a solution casting method for producing a polymer film with the slow axis having approximately invariable direction, which preferably applied to an electronic display and the like.

### DISCLOSURE OF INVENTION

In order to achieve the above objects and other objects, a polymer film of the present invention was produced by casting a dope containing a polymer and a solvent onto a support, drying the dope, peeling the dope as a film, enlarging a width of the film by stretching the film, and performing a relaxation such that the width becomes shorter by a predetermined value, wherein a misalignment of a slow axis from a widthwise direction of the film was less than 2.0° at any position on the film. It is preferable that the stretching and relaxation were performed with holding both side edge portions of the film by a holding device.

It is preferable that when a width of the film right before the stretching was L1 (mm), a maximum width of the film in the stretching was L2 (mm) and a width of the film right after the relaxation was L3 (mm), the stretching and relaxation were performed so as to satisfy a following formula,

3<{(L2−L3)/L1}×100<9

It is preferable that a temperature for heating the film was almost constant, especially in a range of 50° C. to 180° C., during the stretching and relaxation.

It is preferable that the polymer film is an optical film. In addition, it is preferable that the polymer film is a cellulose ester film. The cellulose ester film is preferably a cellulose acylate film, particularly a cellulose acetate film, especially a cellulose triacetate film. The cellulose ester film can be used as optical functional films, such as a base film of photosensitive material, a protective film of a polarizing plate, a base film of an optical compensation film and the like. The optical functional film can be preferably applied to liquid crystal displays.

A solution casting method of the present invention comprising steps of:

casting a dope onto a support, the dope containing a polymer and a solvent;

drying the dope;

peeling the dope as a film;

enlarging a width of the film by stretching the film with holding both side edge portions of the film by a holding device;

performing a relaxation with continuing the holding, such that the width becomes shorter by a predetermined value; and

wherein when a width of the film right before the stretching is L1 (mm), a maximum width of the film in the stretching is L2 (mm) and a width of the film right after the relaxation is L3 (mm), the stretching and relaxation are performed so as to satisfy a following formula,

3<{(L2−L3)/L1}×100<9

It is preferable that a temperature for heating the film is almost constant, especially in a range of 50° C. to 180° C., during the stretching and relaxation. In addition, it is preferable that a misalignment of a slow axis of the film from a widthwise direction of the film is less than 2.0° at any position on the film.

It is preferable that the polymer is cellulose ester. The cellulose ester is preferably cellulose acylate, particularly cellulose acetate, especially cellulose triacetate.

According to the polymer film of the present invention, since produced by casting the dope containing the polymer and the solvent onto the support, drying the dope, peeling the dope as the film, enlarging the width of the film by stretching the film, and performing the relaxation such that the width becomes shorter by the predetermined value, wherein the misalignment of the slow axis from the widthwise direction of the film was less than 2° at any position on the film, the polymer film can have a superior optical isotropy. Accordingly, the polymer film can be preferably used as optical functional films, such as a protective film of a polarizing plate and a base film of an optical compensation film for widening a view angle.

According to the solution casting method of the present invention, since the film is enlarged in the widthwise direction by the stretching, and applied the relaxation such that the width becomes shorter by a predetermined value, wherein when the width of the film right before the stretching is L1 (mm), the maximum width of the film in the stretching is L2 (mm) and the width of the film right after the relaxation is L3 (mm), the stretching and relaxation are performed so as to satisfy the formula 3<(L2−L3)/L1×100<9, the misalignment of the slow axis of the film from the widthwise direction of the film caused by the bowing phenomenon can be corrected. The misalignment can be less than 2.0° by the above method. In most preferable conditions, the misalignment can be less than 1.0°.

### BRIEF DESCRIPTION OF DRAWINGS

FIG. 1 is a schematic diagram of a film production line in which a solution casting method of the present invention is performed;

FIG. 2 is an explanatory view for relaxation of drawing the film in a tenter dryer;

FIG. 3 is a graph showing a relation between relaxation ratio and axial misalignment range;

FIG. 4 is an explanatory view for a slow axis in a cellulose ester film of the present invention.

### BEST MODE FOR CARRYING OUT THE INVENTION

As a polymer used in the present invention, there is a cellulose ester. As one of the cellulose ester, in a cellulose acylate to be used in the present invention, the degree of the acyl substitution preferably satisfies all of the following formulae (I)-(III):

2.5≦A+B≦3.0 (I)

0≦A≦3.0 (II)

0≦B≦2.9 (III)

In these formulae, A is a degree of substitution of the hydrogen atom of the hydroxyl group to the acetyl group, and B is a degree of substitution of the hydrogen group to the acyl group having 3-22 carbon atoms. Preferably, at least 90 wt. % of the cellulose acylate particles has diameter from 0.1 mm to 4 mm. Note that in the present invention, the polymer is not limited to the cellulose ester.

The cellulose is constructed of glucose units making ?-1,4 combination, and each glucose unit has a liberated hydroxyl group at second, third and sixth positions. Cellulose acylate is a polymer in which part or whole of the hydroxyl groups are esterified so that the hydrogen is substituted by acyl groups. The degree of substitution for the acyl groups in cellulose acylate is a degree of esterification at second, third or sixth position in cellulose. Accordingly, when all (100%) of the hydroxyl group at the same position are substituted, the degree of substitution at this position is 1.

When the degrees of substitution for the acyl groups at the second, third or sixth positions are respectively described as DS1,DS2,DS3, the total degree of substitution for the acyl groups at the second, third or sixth positions (namely DS2+DS3+DS6) is preferably in the range of 2.00 to 3.00, particularly in the range of 2.22 to 2.90, especially in the range of 2.40 to 2.88. Further, DS6/(DS2+DS3+DS6) is preferably at least 0.32, and particularly 0.322, and especially in the range of 0.324 to 0.340.

The sort of acyl group to be contained in the cellulose acylate of the present invention is may be only one, and two or more sorts of the acyl group may be contained. If the number of the sorts of the acyl groups is at least two, it is preferable that one of the sorts is acetyl group. If the total degree of substitution for the acetyl groups and that for other acyl groups at the second, third or sixth positions are respectively is described as DSA and DSB, the value DSA+DSB is preferably in the range of 2.2 to 2.86, and particularly in the range of 2.40 to 2.80. Further, the DSB is preferably at least 1.50, and especially at least 1.7. Further, in the DSB, the percentage of a substituent at the sixth position is preferably at least 28%, particularly at least 30%, especially at least 31% and most especially at least 32%. Further, the value DSA+DSB at sixth position is at least 0.75, particularly at least 0.80, and especially 0.85. From cellulose acylate satisfying the above conditions, a solution (or dope) having a preferable dissolubility can be prepared. Especially when non-chlorine type organic solvent is used, the adequate dope can be prepared, since the dope can be prepared so as to have a low viscosity and the filterability becomes higher.

The cellulose acylate made from either of linter and pulp cotton is usable in the embodiment, but the one from the linter cotton is preferably used.

The acyl group having at least 2 carbon atoms may be aliphatic group or aryl group, and is not restricted especially. As examples of the cellulose acylate, there are alkylcarbonyl ester, alkenylcarbonyl ester, aromatic carbonyl ester, aromatic alkylcalbonyl ester and the like. Further, the cellulose acylate may be also esters having other substituents. The preferably substituents are propionyl group, butanoyl group, pentanoyl group, hexanoylgroup, octanoylgroup, decanoylgroup, dodecanoylgroup, tridecanoyl group, tetradecanoyl group, hexadecanoyl group, octadecanoyl group, iso-butanoyl group, t-butanoyl group, cyclohexane carbonyl group, oleoyl group, benzoyl group, naphtylcarbonyl group, cinnamoyl group and the like. Among them, propionyl group, butanoyl group, dodecanoyl group, octadecanoyl group, t-butanoyl group, oleoyl group, benzoyl group, naphtyl carbonyl group, cinnamoyl group and the like are particularly preferable, and propionyl group and butanoyl group are especially preferable.

In the present invention, the polymer is not limited to the cellulose ester. As other polymers, there are polyethylene terephthalate, polyethylene naphthalate, polymethyl methacrylate, polycarbonate, regenerated cellulose ester, diacetyl cellulose, triacetyl cellulose, norbornene, polystyrene, polyvinyl chloride, polyvinylidene chloride, polyvinyl alcohol, polyether sulfone, polyether ketone, polyethylene, polypropylene, polyimide, polyamide, poly-4-methyl-1-pentene and the like.

Solvent compounds for preparing the dope are aromatic hydrocarbon (for example, benzene toluene and the like), halogenated hydrocarbons (for example, dichloromethane, chloroform, chlorobenzene and the like), alcohols (for example methanol, ethanol, n-propanol, n-butanol, diethylene glycol and the like), ketones (for example acetone, methylethyl ketone and the like), esters (for example, methylacetate, ethylacetate, propylacetate and the like), ethers (for example tetrahydrofuran, methylcellosolve and the like) and the like.

The preferable solvent compounds are the halogenated hydrocarbons having 1 to 7 carbon atoms, and dichloromethane is especially preferable. In view of physical properties such as optical properties, a solubility, a peelability from a support, a mechanical strength of the film and the like, it is preferable to use at least one sorts of the solvent compounds having 1 to 5 carbon atoms with dichloromethane. The content of the alcohols is preferably in the range of 2 wt. % to 25 wt. %, and especially in the range of 5 wt. % to 20 wt. % to total solvent compounds in the solvent. As concrete example of the alcohols, there are methanol, ethanol, n-propanol, isopropanol, n-butanol, and the like. It is preferable to use methanol, ethanol, n-butanol or a mixture thereof.

Recently, in order to reduce the influence on the environment, the solvent containing no dichloromethane is proposed. In this case, the solvent contains ethers with 4 to 12 carbon atoms, ketones with 3 to 12 carbon atoms, esters with 3 to 12 carbon atom, or a mixture of them. The ethers, ketones, esthers may have a cyclic structure. At least one solvent compound having at least two functional groups thereof (—O—, —CO—, —COO—) may be contained in the organic solvent. In this case, the number of carbon atoms may be at most the above values for each compound of the functional group. Note that the organic solvent compound may have other functional group such as alcoholic hydroxyl group.

The cellulose acylate is described in detail in the Japanese patent publication No. 2005-104148, and the description of this application can be applied to the present invention. Further, as the solvent of cellulose acylate and other additives, this application discloses plasticizers, deteoriation inhibitor, optical anisotropy controlling agent, dye, matting agent, peeling agent are in detail.

In the present invention, preferably, one or more UV-absorbing agent is preferable to be contained in the film. Since having the dimensional stability, the cellulose acylate film is used in the polarizing filter, the liquid crystal display and the like. In view of the protection of the deterioration of them, the UV-absorbing agent is preferably excellent in absorbing UV-ray whose wavelength is equal or less than 370 nm. Further, in view of the displayability of the LCD, the UV-absorbing agent preferably does not absorb visible ray whose wavelength is equal or more than 400 nm. As the UV-absorbing agent, there are, for example, oxybenzophenone type compounds, benzotriasol type compounds, salicylic acid ester type compounds, benzophenone type compounds, cyanoacrylate type compounds, nickel complex salt type compounds.

As the preferable UV-absorbing agent, there are 2-(2′-hydroxy-5′-methylphenyl)benzotriazol; 2-(2′-hydroxy-3′,5′-di-tert-butylphenyl)benzotriazol; 2-(2′-hydroxy-3′-tert-butyl-5′-methylphenyl)benzotriazol; 2-(2′-hydroxy-3′,5′-di-tert-butylphenyl)-5-chlorobenzotriazol; 2-(2′-hydroxy-3′-(3″,4″,5″,6″-tetrahydrophthalimidomethyl)-5′-methylphenyl)benzotriazol; 2,2-methylenebis(4-(1,1,3,3-tetramethylbutyl)-6-(2H-benzotriazol-2-yl)phenol); 2-(2′-hydroxy-3′-tert-butyl-5′-methylphenyl)-5-chlorobenzotriazol; 2,4-dihydroxybenzophenone; 2,2′-dihydroxy-4-metoxybenzophenone; 2-hydroxy-4-metoxy-5-sulfobenzophenone; bis(2-metoxy-4-hydroxy-5-benzoylphenylmethane); (2,4-bis-(n-octylthio)-6-(4-hydroxy-3,5-di-tert-butylanylino)-1,3,5-triazine; 2-(2′-hydroxy-3′,5′-di-tert-butylphenyl)-5-chlorobenzotriazol; (2(2′-hydroxy-3′,5′-di-tert-amylphenyl)-5-chlorobenzotriazol; 2,6-di-tert-butyl-p-crezol; pentaerythrityl-tetrakis[3-(3,5-di-tert-butyl-4-hydroxyphenyl)propionate]; triethyleneglycol-bis[3-(3-tert-butyl-5-methyl-4-hydroxyphenyl)propionate]; 1,6-hexanediol-bis[3-(3,5-di-tert-butyl-4-hydroxyphenyl)propionate], 2,4-bis-(n-octylthio)-6-(4-hydroxy-3,5-di-tert-butylanilino)-1,3,5-triadine; 2,2-thio-diethylenebis[3-(3,5-di-tert-butyl-4-hydroxyphenyl)propionate], octadecyl-3-(3,5-di-tert-butyl-4-hydroxyphenyl)propionate, N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, tris-(3,5-di-tert-butyl-4-hydroxybenzyl)-isocianurate and the like. Especially preferable are 2,4-bis-(n-octylthio)-6-(4-hydroxy-3,5-di-tert-butylanylino)-1,3,5-triadine; 2(2′-hydroxy-3′,5′-di-tert-butylphenyl)-5-chlorobenzotriazol; (2(2′-hydroxy-3′,5′-di-tert-amylphenyl)-5-chlorobenzotriazol; 2,6-di-tert-butyl-p-crezol, pentaerythrityl-tetrakis[3-(3,5-di-tert-butyl-4-hydroxyphenyl)propionate]; and triethyleneglycol-bis[3-(3-tert-butyl-5-methyl-4-hydroxyphenyl)propionate]. Further, the following compound can be used in combination with the above UV-absorbing agents; for example, metallic nonactivator of hydradine type, such as N,N′-bis[3-(3,5-di-tert-butyl-4-hydroxyphenyl)propionyl]hydra dine, processing stabilizers of phosphor type, such as tris(2,4-di-tert-butylphenyl)phosphite and the like. The added amount of these compound is preferably 1 ppm to 2.0 ppm in mass ratio to cellulose acylate, and particularly 10 ppm to 5000 ppm.

Further, it is preferable to use the UV-absorbing agents described in Japanese Patent Laid-Open Publications No. 6-148430 & 7-11056. The UV-absorbing agents preferably used in the present invention have high transparency and high efficiency for preventing the deterioration of the polarizing filter or the liquid crystal elements. Especially preferable are the benzotriazol type UV-absorbing agents which reduces the unnecessary coloring. The quantity of the UV-absorbing agent to be used in not constant and depending on the sorts of the compounds, the conditions of use and so on. However, the quantity is preferably in the range of 0.2 g to 5.0 g, and preferably in the range of 0.4 g to 1.5 g, and especially in the range of 0.6 g to 1.0 g in 1 m² cellulose acylate film.

As the UV-absorbing agents to be used in the present invention, there are optical stabilizer in catalogue of “Adekastab”, optical stabilizers and UV-absorbing agents in catalogue of Tinuvin of Ciba Specialty Chemicals Inc., SEESORB, SEENOX, SEETEC and the like in catalogue of SHIPRO KASEI KAISHA. Further, there are VIOSORB of Kyodo Chem. Co. Ltd and UV-absorbing agents of Yoshitomi Pharmaceut Ind., Ltd.

Japanese Patent Laid-Open Publication No. 2003-043259 discloses the optical film to be used in the polarizing filter and the display device. The film is excellent in color reproducibility and endurance in the illumination of the UV-ray. In the UV-wavelength range, the spectral transmittance of the film is from 50% to 95% at 390 nm and at most 5% at 350 nm.

The compounds to be used as optical anisotropy controlling agents will be described in followings.

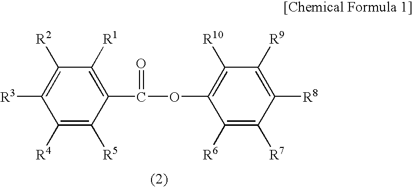

In the formula (2), R¹-R¹⁰ are independently hydrogen atom or substituent T which will be explained later. At least one of R¹-R⁵ is an electron donative substituent. The substituent having electron-donating property is preferably one of R¹,R³ and R⁵, and especially R³.

In the group having electron-donating property, a σp value of Hammet is at most zero. The σp value of Hammet described in Chem. Rev., 91, 165 (1991) is preferably at most zero, and especially in the range of −0.85 to 0, Such groups are, for example, alkyl groups, alkoxy groups, amino group, hydroxy group, and the like.

The groups having electron-donating property are preferably alkyl groups and alkoxy groups, and particularly alkoxy groups in which the number of carbon atoms is preferably from 1 to 12, particularly from 1 to 8, especially from 1 to 6, and more especially 1 to 4.

R¹ is preferably hydrogen atom or a substituent having electron-donating property, particularly alkyl group, alkoxy group, amino group and hydroxy group, and especially alkyl group having 1-4 carbon atoms and alkoxy group having 1-12 carbon atoms. R¹ is more especially alkoxy group in which the number of carbon atoms is preferably from 1 to 12, particularly from 1 to 8, especially from 1 to 6, and more especially 1 to 4, and most especially methoxy group.

R² is preferably hydrogen atom, alkyl group, alkoxy group, amino group and hydroxy group, particularly hydrogen atom, alkyl group and alkoxy group. R² is more especially hydrogen atom, alkyl group which has 1-4 carbon atoms or is further preferably methyl group, alkoxy group in which the number of carbon atoms is preferably from 1 to 12, particularly from 1 to 8, especially from 1 to 6, and more especially 1 to 4. The most especially group as R² is hydrogen atom, methyl group and methoxy group.

R³ is preferably hydrogen atom or a substituent having electron-donating property, particularly hydrogen atom, alkyl group, alkoxy group, amino group and hydroxy group, and especially alkyl group and alkoxy group. R³ is more especially alkoxy group in which the number of carbon atoms is preferably from 1 to 12, particularly from 1 to 8, especially from 1 to 6, and more especially 1 to 4. R³ is most especially n-propoxy group, ethoxy group and methoxy group.

R⁴ is preferably hydrogen atom or a substituent having electron-donating property, particularly hydrogen atom, alkyl group, alkoxy group, amino group and hydroxy group, and especially hydrogen atom, alkyl group having 1-4 carbon atoms and alkoxy group having 1-12 carbon atoms. R⁴ is more especially alkoxy group in which the number of carbon atoms is preferably from 1 to 12, particularly from 1 to 8, especially from 1 to 6, and more especially 1 to 4. R⁴ is most especially hydrogen atom, methyl group, and methoxy group.

R⁵ is preferably hydrogen atom, alkyl group, alkoxy group, amino group and hydroxy group, particularly hydrogen atom, alkyl group and alkoxy group. R⁵ is more especially hydrogen atom, alkyl group which has 1-4 carbon atoms or is further preferably methyl group, and alkoxy group in which the number of carbon atoms is preferably from 1 to 12, particularly from 1 to 8, especially from 1 to 6, and more especially 1 to 4. The most especially group as R⁵ is hydrogen atom, methyl group and methoxy group.

R⁶,R⁷, R⁹ and R¹⁰ preferably hydrogen atom, alkyl group having 1 to 12 carbon atoms, alkoxy group having 1 to 12 carbon atom and halogen atoms, particularly hydrogen atom and halogen atoms, and especially hydrogen atom.

R⁸ is preferably hydrogen atom, alkyl group having 1-4 carbon atoms, alkynyl group having 2-6 carbon atoms, aryl group having 6-12 carbon atoms, alkoxy group having 1-12 carbon atoms, and aryloxy group having 6-12 carbon atoms. R⁸ is particularly preferably alkoxy carbonyl group having 2-12 carbon atoms, acylamino group having 2-12 carbon atoms, ciano group or halogen atom. These groups may have a substituent T which will be explained later.

R⁸ is preferably alkyl group having 1-4 carbon atoms, alkynyl group having 2-6 carbon atoms, aryl group having 6-12 carbon atoms, alkoxy group having 1-12 carbon atoms, aryloxy group having 2-12 carbon atoms, and particularly aryl group having 6-12 carbon atoms, alkoxy group having 1-12 carbon atoms, aryloxy group having 6-12 carbon atoms. R⁸ is especially preferably alkoxy group in which the number of carbon atoms is preferably from 1 to 12, particularly from 1 to 8, especially from 1 to 6, and more especially 1 to 4. The most especially group as R⁸ is methoxy group, ethoxy group, n-propoxy group, iso-propoxy group and n-butoxy group.

In Chemical Formula 1 (formula (2)), there are preferable compounds shown in Chemical Formula 2 (following formula (2-A)).

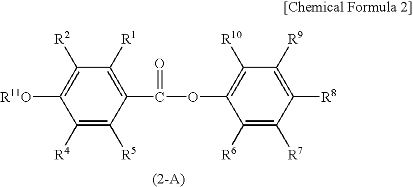

In the formula (2-A), R¹¹ is alkyl group, and R¹,R³,R⁴-R⁷, R⁹,R¹⁰ are independently hydrogen atom or substituents. R⁸ is hydrogen atom, alkyl group having 1-4 carbon atoms, alkynyl group having 2-6 carbon atoms, aryl group having 6-12 carbon atoms, alkoxy group having 1-12 carbon atoms, aryloxy group having 6-12 carbon atoms, alkoxy carbonyl group having 2-12 carbon atoms, acylamino group having 2-12 carbon atoms, ciano group and halogen atom. In Chemical Formula 2 (formula (2-A)), R¹,R²,R⁴-R¹⁰ and the preferable range of the number of the carbon atoms in one molecule are the same as in Chemical Formula 1 (formula (2)).

In formula (2-A), R¹¹ is preferably alkyl group having 1-12 carbon atoms, and may have straight chain or branched chain. Further, R¹¹ may have substituents and be preferably alkyl group having 1-12 carbon atoms, particularly alkyl group having 1-8 carbon atoms, especially alkyl group having 1-6 carbon atoms, and more especially alkyl group having 1-4 carbon atoms (for example, methyl group, ethyl group, n-propyl group, iso-propyl group, n-butyl group, iso-butyl group, tert-butyl group and the like.

In Chemical Formula 1 (formula (2)), there are preferable compounds shown in Chemical Formula 3 (following formula (2-B))

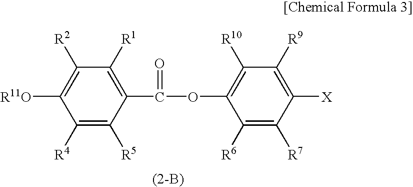

In the formula (2-B), R¹,R², R⁴-R⁷, R⁹,R¹⁰ are independently hydrogen atom or substituents. R¹¹ is an alkyl group having 0.1 to 12 carbon atoms. X is alkyl group having 1-4 carbon atoms, alkynyl group having 2-6 carbon atoms, aryl group having 6-12 carbon atoms, alkoxy group having 1-12 carbon atoms, aryloxy group having 6-12 carbon atoms, alkoxy carbonyl group having 2-12 carbon atoms, acylamino group having 2-12 carbon atoms, ciano group and halogen atom.

In Chemical Formula 3 (formula (2-B)), R¹, R², R⁴-R⁷, R⁹,R¹⁰ and the preferable range of the number of the carbon atoms in one molecule are the same as in Chemical Formula 1 (formula (2)), and R⁸ and the preferable range of the number of the carbon atoms in one molecule are the same as in Chemical Formula 2 (formula (2-A)).

If R¹,R²,R⁴,R⁵ are hydrogen atoms, X is preferably alkyl group, alkynyl group, aryl group, alkoxy group, aryloxy group, and particularly aryl group, alkoxy group, aryloxy group, especially alkoxy group in which the number of carbon atoms is preferably from 1 to 12, particularly from 1 to 8, especially from 1 to 6, and more especially 1 to 4. The most especially preferable group as X is methoxy group, ethoxy group, n-propoxy group, iso-propoxy group and n-butoxy group.

If at least one of R¹,R²,R⁴ and R⁵ is substituent, X is preferably alkynyl group, aryl group, alkoxy carbonyl group and ciano group, and preferably aryl group having 6-12 carbon atoms, alkoxy carbonyl group having 2-12 carbon atoms and ciano group. Further, X is especially preferably ciano group, aryl group which has 6-12 carbon atoms (particularly phenyl group, p-cianophenyl group and p-methoxyphenyl group), alkoxycarbonyl group which has preferably 2-12, particularly 2-6 and especially 2-4 carbon atoms and is especially methoxy carbonyl group, ethoxy carbonyl group and n-propoxycarbonyl group. The most especially group as X is phenyl group, methoxy carbonyl group, ethoxy carbonyl group, n-propoxy group and cyano group.

In Chemical Formula 1 (formula (2)), there are preferable compounds shown in Chemical Formula 4 (following formula (2-C)).

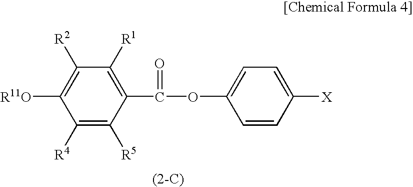

In Chemical Formula 4 (formula (2-C)), R¹,R²,R⁴,R⁵,R¹¹,X and the preferable range of the number of the carbon atoms in one molecule are the same as in Chemical Formula 3 (formula (2-B)).

In Chemical Formula 1 (formula (2)), there are preferable compounds shown in Chemical Formula 5 (following formula (2-D)).

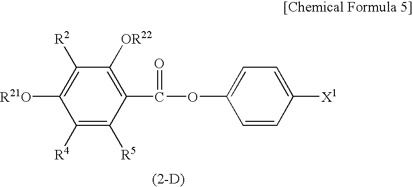

In Chemical Formula 5 (formula (2-D)), R²,R⁴,R⁵ and the preferable range of the number of the carbon atoms in one molecule are the same as in Chemical Formula 4 (formula (2-C)). R²¹,R²² are independently alkyl group having 1-4 carbon atoms. X¹ is aryl group having 6-12 carbon atoms, alkoxylcarbonyl group having 2-12 carbon atoms, or cyano group.

R²¹ is alkyl group having 1-4 carbon atoms, preferably alkyl group having 1-3 carbon atoms, and particularly methyl group and ethyl group. R²² is alkyl group having 1-4 carbon atoms, preferably alkyl group having 1-3 carbon atoms, particularly methyl group and ethyl group, and especially methyl group.

X¹ is aryl group having 6-12 carbon atoms, alkoxylcarbonyl group having 2-12 carbon atoms, or cyano group, and preferably aryl group having 6-10 carbon atoms, alkoxylcarbonyl group having 2-6 carbon atoms, or cyano group. X¹ is especially preferably phenyl group, p-cianophenyl group, p-methoxyphenyl group, methoxycarbonyl group, ethoxy carbonyl group, n-propoxy carbonyl group, and cyano group, and more especially phenyl group, methoxycarbonyl group, ethoxycarbonyl group, n-propoxycarbonyl group, and cyano group.

In Chemical Formula 1 (formula (2)), there is most preferable compounds shown in Chemical Formula 6 (following formula (2-E)).

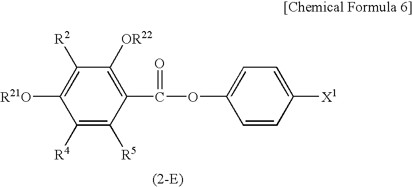

In Chemical Formula 6 (formulae (2-E)), R²,R⁴,R⁵ and the preferable range of the number of the carbon atoms in one molecule are the same as in Chemical Formula 5 (formula (2-D)). As shown in Chemical Formulae 6, OR¹³ is substituent for one of R²,R⁴,R⁵, and R¹³ is alkyl group having 1-4 carbon atoms. R²¹,R²²,X¹ and the preferable range of the number of the carbon atoms in one molecule are the same as in Chemical Formula 5 (formula (2-D)).

Preferably, both R⁴ and R⁵ are OR³, and especially R⁴ is OR¹³. R¹³ is alkyl group having 1-4 carbon atoms, preferably alkyl group having 1-3 carbon atoms, particularly methyl group and ethyl group, and especially methyl group.

In followings, the substituents T will be explained. As the substituents T, there are, for example, alkyl groups in which the number of the carbon atoms is preferably from 1 to 20, particularly from 1 to 12, especially from 1 to 8. Concretely, the alkyl group is methyl group, ethyl group, iso-propyl group, tert-butyl group, n-octyl group, n-decyl group, n-hexadecyl group, cyclopropyl group, cyclopentyl group, cyclohexyl group and the like. Further, as the substituents T, there are, for example, alkenyl groups in which the number of the carbon atoms is preferably from 2 to 20, particularly from 2 to 12, especially from 2 to 8 (concretely, vinyl, allyl group, 2-butenyl group, 3-pentenyl group and the like), alkynyl groups in which the number of the carbon atoms is preferably from 2 to 20, particularly from 2 to 12, especially from 2 to 8 (concretely, propargyl group, 3-pentynyl group and the like).

Further, as the substituents T, there are, for example, aryl groups in which the number of the carbon atoms is preferably from 6 to 30, particularly from 6 to 20, especially from 6 to 12. Concretely there are phenyl group, p-methylphenyl group, naphtyl group and the like. Furthermore, as the substituents T, there are, for example, substituted or non-substituted amino groups in which the number of the carbon atoms is preferably from 0 to 20, particularly from 0 to 10, especially from 0 to 6 (concretely, there are amino group, methylamino group, dimethylamino group, diethylamino group, dibenzylamino group, and the like), alkoxy groups in which the number of the carbon atoms is preferably from 1 to 20, particularly from 1 to 12, especially from 1 to 8 (concretely, methoxy group, ethoxy group, butoxy group and the like), aryloxy groups in which the number of the carbon atoms is preferably from 6 to 20, particularly from 6 to 16, especially from 6 to 12 (concretely, phenyloxy group, 2-naphthyloxy group and the like).

Further, as the substituents T, there are acyl groups in which the number of the carbon atoms is preferably from 1 to 20, particularly from 1 to 16, especially from 1 to 12. Concretely, there are acetyl group, benzoyl group, formyl group, pivaloyl group, and the like. Further, as the substituents, there are alkoxy carbonyl groups in which the number of the carbon atoms is preferably from 2 to 20, particularly from 2 to 16, especially from 2 to 12. Concretely, there are methoxycarbonyl group, ethoxycarbonyl group and the like. Further, as the substituents, there are aryloxycarbonyl groups in which the number of the carbon atoms is preferably from 7 to 20, particularly from 7 to 16, especially from 7 to 10. Concretely, there are phenyloxycarbonyl group and the like. Further, as the substituents, there are acyloxy groups in which the number of the carbon atoms is preferably from 2 to 20, particularly from 2 to 16, especially from 2 to 10. Concretely, there are acetoxy group, benzoyloxy group and the like.

Further, as the substituents, there are acylamino groups in which the number of the carbon atoms is preferably from 2 to 20, particularly from 2 to 16, especially from 2 to 10. Concretely, there are acetylamino group, benzoylamino group and the like. Further, as the substituents, there are alkoxycarbonylamino groups in which the number of the carbon atoms is preferably from 2 to 20, particularly from 2 to 16, especially from 2 to 12. Concretely, there are methoxycarbonylamino group and the like. Further, as the substituents, there are aryloxycarbonylamino groups in which the number of the carbon atoms is preferably from 7 to 20, particularly from 7 to 16, especially from 7 to 12. Concretely, there are phenyloxycarbonylamino group and the like. Further, as the substituents, there are sulfonylamino groups in which the number of the carbon atoms is preferably from 1 to 20, particularly from 1 to 16, especially from 1 to 12. Concretely, there are methanesulfonyl amino group, benzene sulfonylamino group and the like.

Further, as the substituents, there are sulfamoyl groups in which the number of the carbon atoms is preferably from 0 to 20, particularly from 0 to 16, especially from 0 to 12. Concretely, there are sulfamoyl group, methylsulfamoyl group, dimethylsulfamoyl group, phenylsulfamoyl group and the like. Further, as the substituents, there are carbamoyl groups in which the number of the carbon atoms is preferably from 1 to 20, particularly from 1 to 16, especially from 1 to 12. Concretely, there are carbamoyl group, methylcarbamoyl group, diethylcarbamoyl group, phenylcarbamoyl group and the like. Furthermore, as the substituents, there are alkylthio groups in which the number of the carbon atoms is preferably from 1 to 20, particularly from 1 to 16, especially from 1 to 12. Concretely, there are methylthio group, ethylthio group and the like. Furthermore, as the substituents, there are arylthio groups in which the number of the carbon atoms is preferably from 6 to 20, particularly from 6 to 16, especially from 6 to 12. Concretely, there are phenylthio group.

Further, as the substituents, there are sulfonyl groups in which the number of the carbon atoms is preferably from 1 to 20, particularly from 1 to 16, especially from 1 to 12. Concretely, there are mesyl group, tosyl group and the like. Further, as the substituents, there are sulfinyl groups in which the number of the carbon atoms is preferably from 1 to 20, particularly from 1 to 16, especially from 1 to 12. Concretely, there are methane sulfinyl group, benzene sulfinyl group and the like. Further, as the substituents, there are ureido groups in which the number of the carbon atoms is preferably from 1 to 20, particularly from 1 to 16, especially from 1 to 12. Concretely, there are ureido group, methylureido group, phenylureido group and the like. Furthermore, as the substituents, there are phosphoric acid amide groups in which the number of the carbon atoms is preferably from 1 to 20, particularly from 1 to 16, and especially from 1 to 12. Concretely, there are diethylphosphoric acid amide group, phenylphosphoric acid amide group and the like.

Further, as the substituents, there are hydroxy groups, mercapto groups, halogen atoms (fluorine atom, chlorine atom, bromine atom, iodine atom an the like), cyano groups, sulfo groups, carboxy group, nitro group, hydroxamic acid group, sulfino group, hydrazino group, imino group, heterocyclic group in which the number of the carbon atoms is preferably from 1 to 30, particularly from 1 to 12 and there are nitrogen atom, oxygen atom, sulfer atom and the like as the heteroatom. As the heterocyclic group, for example, there are imidazolyl group, pyridyl group, quinoryl group, furyl group, piperidyl group, morphorino group, benzoxazolyl group, benzimidazolyl group, benzthiazolyl group and the like. Further, as the substituents, there are silyl group in which the number of the carbon atoms is preferably from 3 to 40, particularly from 3 to 30 and especially from 3 to 24, and there are trimethyl silyl, triphenyl silyl and the like. When there are two or more substituents, the sorts thereof may be the same or different. Further, the substituents may form a cyclic group.

In followings chemical formulae, concrete examples of the compounds shown in Chemical formula 1 (formula (2)) will be illustrated. However, the present invention is not restricted in the concrete examples.

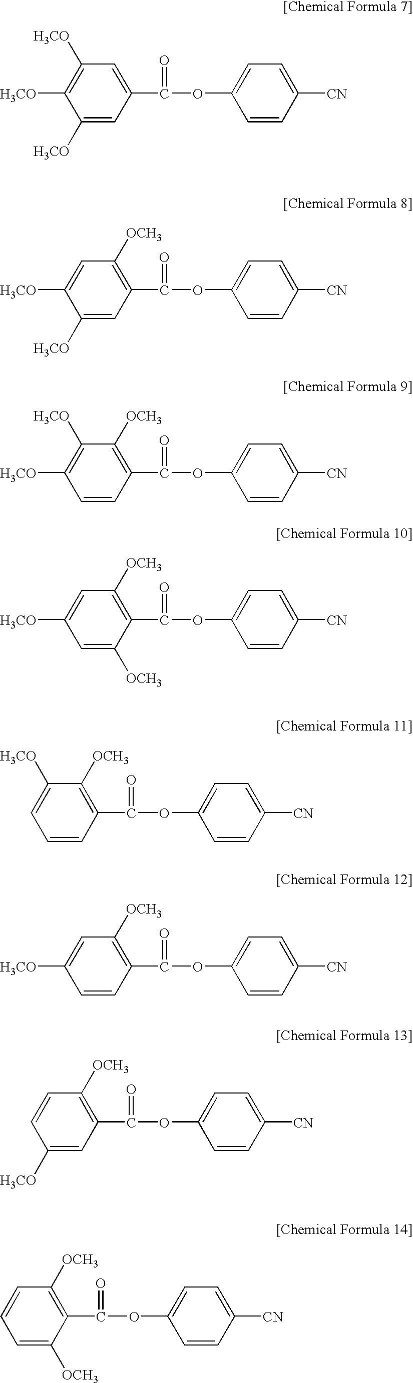

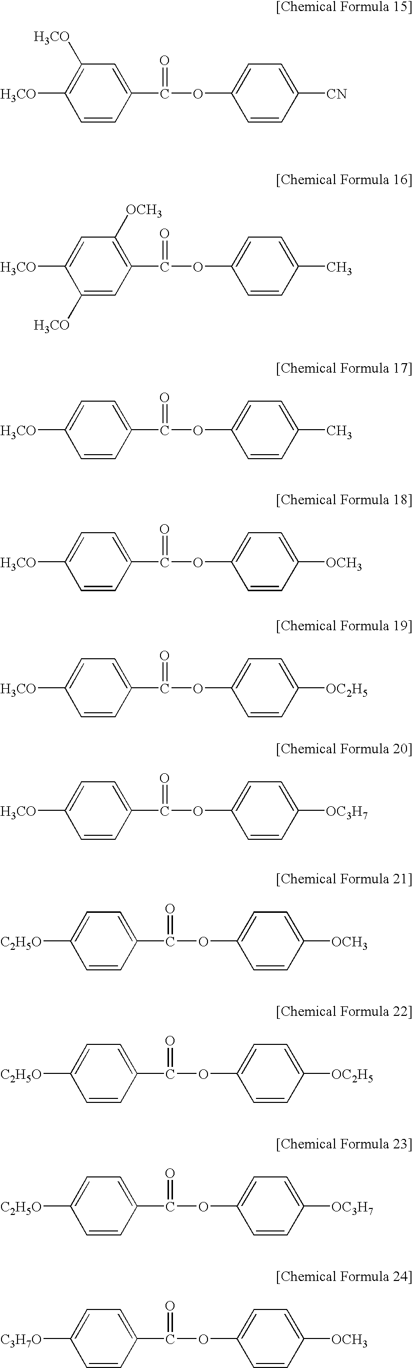

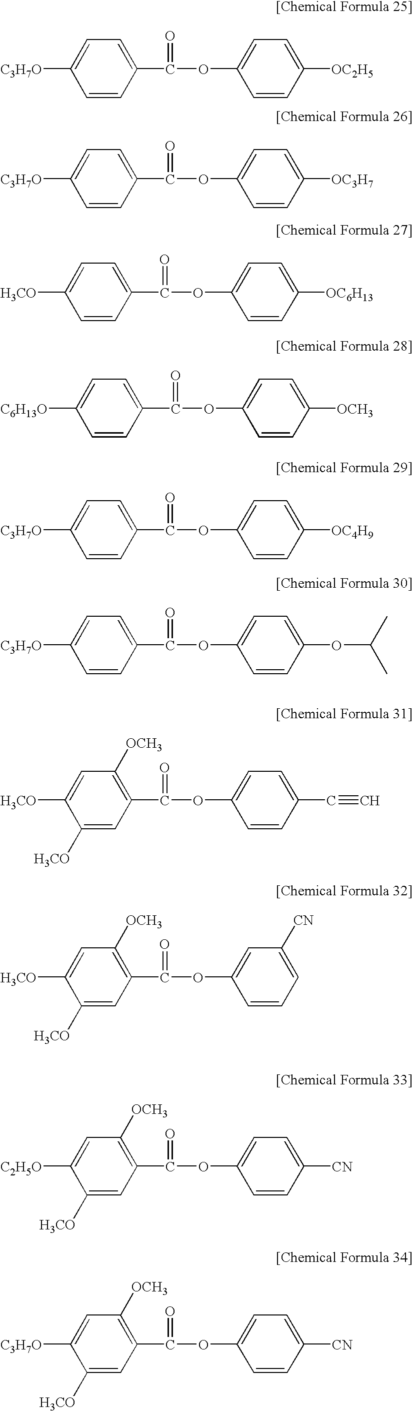

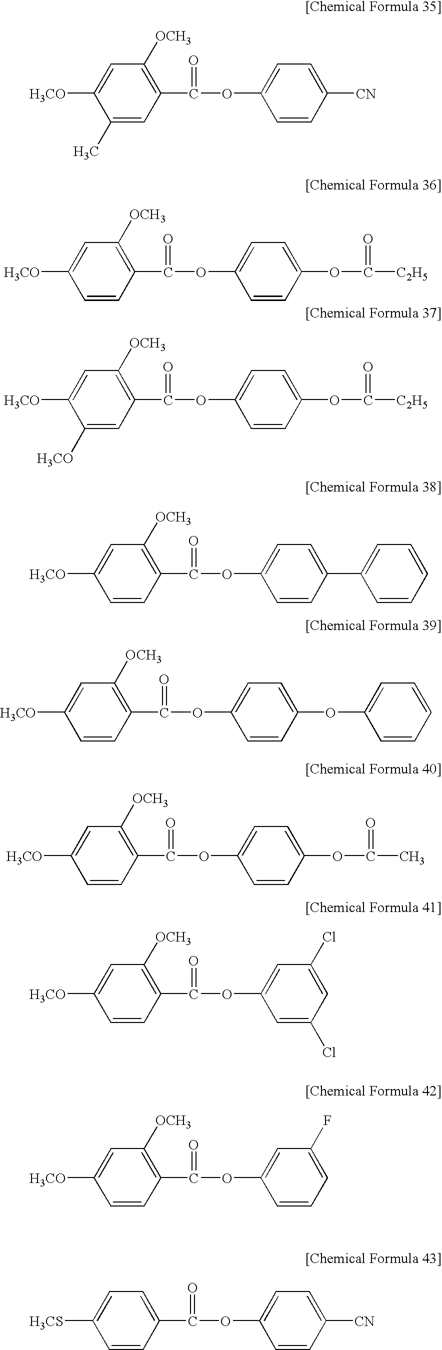

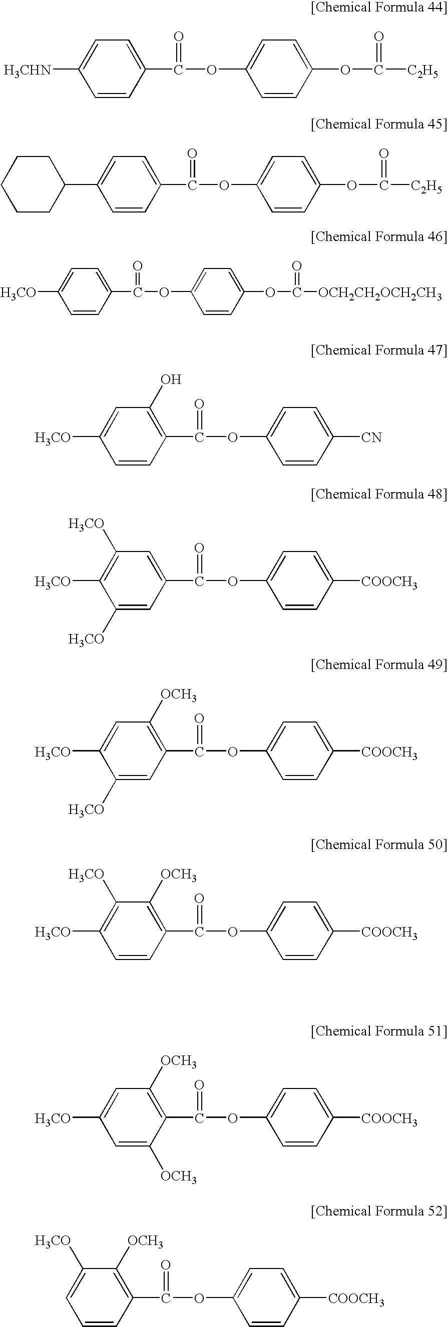

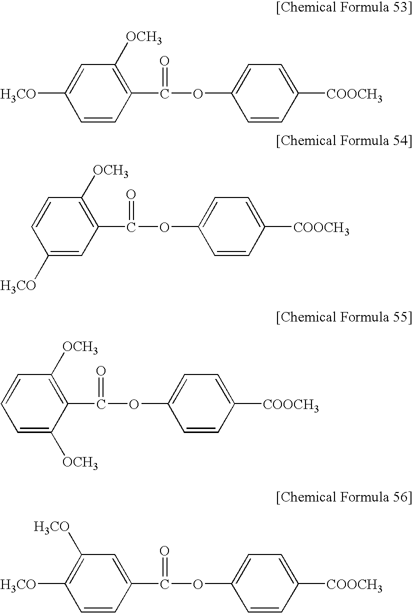

The compounds represented by Chemical Formula 1 (formula (2)) can be produced in a general esterification reaction of substituted benzoic acid and phenol derivatives. The method of the production is not restricted so far as being esterification reaction. For example, there are a method in which a functional group transformation of the substituted benzoic acid to an acid halide is made and thereafter a condensation with the phenol is made, a method in which the dehydration condensation between substituted benzoic acid and the phenol derivatives with use of condensation agent or catalyst, and the like. In consideration of the producing process, the method in which the condensation with phenol is made after the functional group transformation of the substituted benzoic acid to the acid halide.

As the solvent for the reaction, there are hydrocarbon type solvent (preferably toluene, xylene and the like), ether type solvent (preferably diethylether, tetrahydrofuran, dioxane and the like), ketone type solvent, ester type solvent, acetonitril, dimethylformamide, dimethylacetoamide and the like. Single one or the mixture of these compounds may be used as the solvent. Especially preferable solvents are toluene, acetonitril, dimethylformamide, dimethylacetoamide and the like.

The reaction temperature is preferably in the range of 0° C. to 150° C., particularly in the range of 0° C. to 100° C., especially in the range of 0° C. to 90° C., and more especially 20° C. to 90° C. In this reaction, it is preferable not to use a base. When the base is used, the organic and inorganic bases may be used. However, the organic base is preferably used, and pyridine and tertiary alkylamine (preferably triethylamine, ethyldiisopropyl amine and the like) are particularly preferably used.

In the optical properties of celluloseacylate film of the present invention, retardation values Re,Rth are represented by formulae (IV),(V):

Re(λ)=(nx−ny)×d; Formula (IV)

Rth(λ)={(nx+ny)/2−nz}×d Formula (V)

The retardation values Re,Rth preferably satisfy following formulae (VI),(VII):

46 nm≦Re(630)≦200 nm; Formula (VI)

70 nm≦Rth(630)≦350 nm; Formula (VII)

[In formulae, Re(λ) is an in-plane retardation value (unit;nm) at λnm wavelength, Rth(λ) is a thickness retardation value (unit;nm) at λnm wavelength. Further, nx is a refractive index in the direction of the slow axis on a film surface, ny is a refractive index in the direction of the fast axis on a film surface, and nz is a refractive index in the thickness direction of the film. Further, d is the film thickness.]
The retardation values especially preferably satisfy following formulae (VIII),(IX):

46 nm≦Re(630)≦100 nm; Formula (VIII)

180 nm≦Rth(630)≦350 nm; Formula (IX)

The optical properties such as the retardation values Re,Rth change depending on a mass variation and a dimension variation caused by a humidity variation and a period in which the high temperature is kept. Preferably, the change of the values Re,Rth are smaller. In order to reduce the change of the values Re,Rth caused by the humidity variation, the moisture permeability and the equilibrium moisture content of the film is made smaller by using not only cellulose acylate whose degree of acylation at 6^{th} position is large, but also several sorts of hydrophobic additives (plasticizer, retardation controller, UV-absorbing agent and the like). The moisture permeability to cellulose acylate is preferably from 400 g to 2300 g in 1 square meter at 60° C. and 95% RH for 24 hours. The measured value of the equilibrium moisture content is preferably at most 3.4% at 25° C. and 80% RH. When the humidity at 25° C. varies from 10% RH to 80% RH, the retardation values Re,Rth of the optical properties respectively change at most 12 nm and at most 32 nm. The quantity of the hydrophobic additives is preferably from 10% to 30%, particularly from 12% to 25%, and especially 14.5% to 20% in ratio to that of the cellulose acylate. If the additives is volatile and degradable compounds, the mass variation and size variation of the film occur, which causes the change of the optical properties. Accordingly, after 48 hours passes at 80° C. and 90% RH, the mass variation of the film is preferably at most 5%. Similarly, after 24 hours passes at 60° C. and 95% RH, the size variation of the film is preferably at most 5%. Further, even though the size variation and the mass variation occur, the change of the optical properties becomes smaller when the film has the smaller photoelastic coefficient. Therefore, the photoelastic coefficient is preferably at most 50×10⁻¹³ cm²/dyne.

The producing method of the dope used in the present invention is not restricted especially. An example of the producing method will be described in followings. The main solvent compound is dichloromethane, and the mixture solvent into which the alcohols are added was used. TAC and the plasticizers (for example, triphenyl phosphate, biphenyl diphenyl phosphate or the like) are added to the mixture solvent, and the dissolution with the stirring is made to obtain a primary dope. Note that in the dissolving, the heating and the cooling were made so as to increase the dissolubility. Further, the primary dope, the mixture solvent and the UV-absorbing agent (for example, benzotriazol type compound) are mixed and dissolved to obtain a UV-absorbing agent liquid (hereinafter first additive liquid). Further, the primary dope, the mixture solvent and the matting agent are mixed and dispersed to obtain a matting agent liquid (hereinafter second additive liquid). Further, as to the object, another additive liquid containing the deterioration inhibitors, optical anisotropy controlling agent, a dye and a peeling agent may be prepared.

After the preparation of the primary dope and the additive liquids, in order to remove the impurities, a filtration is preferably made by a filtration apparatus. Preferably, the filtration apparatus includes a filter, whose averaged pore diameter is at most 100 μm, and performs the filtration at 50 L/hr flow rate of the filtration. Thereafter, foam is preferably removed from the primary dope and the additive liquids.

Methods for dissolving materials, raw materials and additives, filtrating, removing the voids, and adding are explained in Japanese Patent publication No. 2005-104148. The description of this publication can be applied to the present invention.

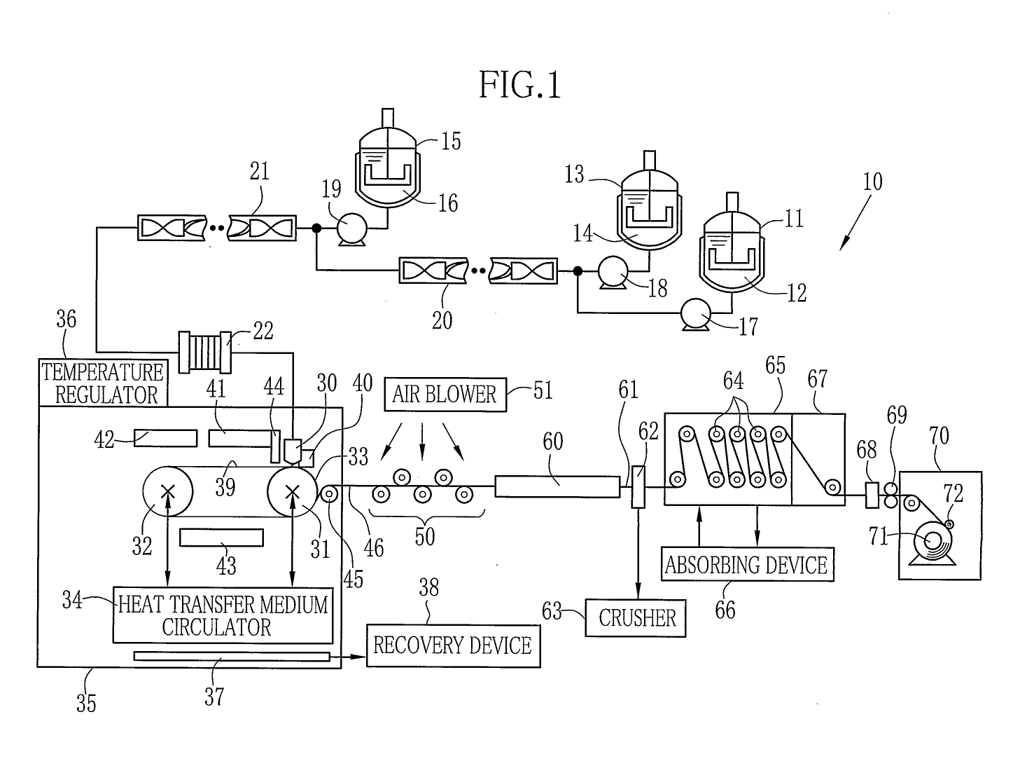

In FIG. 1, a film production apparatus 10 includes a stock tank 11 containing the first additive liquid 12, a stock tank 13 containing the second additive liquid 14, and a stock tank 15 containing a primary dope 16. The stock tanks 11,13,15 are respectively provided with pumps 17,18,19 for feeding the first additive liquid 12, the second additive liquid 14 and the primary dope 16 therein.

After mixing the first additive liquid 12 and the second additive liquid 14, they are fed through a static mixer 20 to become a uniform adding liquid. Then, the adding liquid is added to the primary dope 16 and the mixture is fed through a static mixer 21. Thus a uniform liquid is obtained as a casting dope. After the filtration with use of a filtration device 22, the casting dope is fed to a casting die 30.

Another type of inline mixer (for example a sulzer mixer) can be used as same as the static mixer. It is preferable that plural inline mixers each of which has a structure for the mixing different from the other mixer are serially connected.

Preferably, at least either the static mixer or the sulzer mixer is used as the inline mixer. When the static mixer is used, the mixer has preferably 6 to 90 elements, more preferably 6 to 60 elements.

In case that both the static mixer and the sulzer mixer are equipped as the inline mixers, the sulzer mixer is preferably disposed at a position upstream from the static mixer. Further, a distance between the sulzer mixer and an additive liquid inlet is preferably in a range of 5 mm to 150 mm, more preferably in a range of 5 mm to 15 mm. In addition, an upstream side edge of an element of the sulzer mixer is preferably disposed near an inner surface of the pipe in which the primary dope flows.

Preferably, a first filtration device for filtrating the primary dope is disposed at a position upstream from the inline mixer, and the adding liquid is mixed into the dope filtrated by the first filtration device. In addition, it is preferable that a second filtration device for filtrating the casting dope is disposed at a position downstream from the inline mixer, and the casting dope mixed by the inline mixer is filtrated by the second filtration device.

Preferably, the embodiment is performed with satisfying following conditions.

(1) 1≦V1/V2≦5 when V1 is defined as a flow velocity of the adding liquid and V2 is defined as the flow velocity of the primary dope 16.

(2) a ratio of the adding liquid to the primary dope 16 is in a range of 0.1% to 50% by rate of flow volume.

(3) 1000≦N2/N1≦100000, 5000 cP≦N2 (at 20° C.)≦500000 cP and 0.1 cP≦N2 (at 20° C.)<100 cP when N1 is defined as viscosity of the adding liquid and N2 is defined as viscosity of the primary dope.

(4) The shear speed of the primary dope is in a range of 0.1(1/s) to 30(1/s).

(5) The polymer is the cellulose acylate.

(6) The adding liquid is the solution containing the main solvent of the primary dope.

(7) The added liquid is the solution containing the main solvent of the primary dope, and the composition of the additive liquid is different from the primary dope.

(8) The adding liquid is the solution including the main solvent of the primary dope, and further including at least one kind of UV absorbing agent.

(9) The adding liquid is the solution including the main solvent of the primary dope, and being made from dispersed particles of at least one kind of inorganic or organic material.

(10) The adding liquid is the solution including the main solvent of the primary dope, and further including at least one kind of peeling agent.

(11) The adding liquid is the solution including the main solvent of the primary dope, and further including at least one kind of poor solvent of the polymer.

Below the casting die 30, there is a belt 33 supported by rollers 31,32. The belt 33 endlessly and circulatory move in accordance with a rotation of the rollers 31, 32 by a driving device (not shown). The moving speed of the belt 33, namely a casting speed is preferably in the range of 10 m/min to 200 m/min. Furthermore, the rollers 31,32 are connected to a heat transfer medium circulator 34 for keeping a surface temperature of the belt 33 to a predetermined value. In each roller 31,32, there is a heat transfer passage in which a heat transfer medium of the predetermined temperature is fed, so as to keep the temperature of the rollers 31,32 to the predetermined value. Thus the surface temperature of the belt 33 is controlled to the predetermined value. Note that the surface temperature is preferably from −20° C. to 40° C.

The casting die 30, the belt 33 and the like are contained in a casting chamber 35 to which a temperature regulator 3.6 is connected. The temperature in the casting chamber 35 is preferably in the range of −10° C. to 57° C. Further, a condenser 37 is provided for condensing a solvent vapor. The condensed organic solvent is recovered into a recovering device 38, and the reproduction is made for reusing as the solvent for preparing the dope.

The casting die 30 casts the casting dope on the belt 33 to form a casting film 39, while the casting dope form a bead above the belt 33. Note that the temperature of the casting dope is preferably from −10° C. to 57° C. Further, in order to stabilize the formation of the bead, a decompression chamber 40 is preferably provided in a rear side of the bead, so as to control the pressure. The casting film 39 is conveyed by the moving belt 33, and at the same time it is preferable to feed a drying air to the casting film 39 from air blowers 41,42,43 provided around the belt 33, such that the organic solvent may evaporate from the casting film 39. The surface condition of the film sometimes changes when the drying air is applied onto the casting film 39 just after the formation thereof. In order to reduce the change of the surface condition, a wind shielding plate 44 is preferably provided. Note that although the belt is used as a support in this figure, a drum may be used as the support. In this case, the surface temperature of the drum is preferably in the range of −20° C. to 40° C.

When having a self-supporting property, the casting film 39 is peeled as a wet film 46 from the belt with support of a peel roller 45. Thereafter, the wet film 46 is transported in an interval section 50 provided with plural rollers. In the interval section 50, a drying air at a predetermined temperature is fed from an air blower 51 such that the drying of the wet film 46 may proceed. The temperature of the drying air is preferably in the range of 20° C. to 250° C. Note that in the interval section 50, the rotational speed of the rollers in the upstream side is faster than those in the downstream side, so as to draw the wet film 46. Thus the wet film 46 is transported in a tenter dryer 60 so as to make the drying, while both side edges are held by the clips. Note that methods of transporting and drying will be explained later.

The wet film 46 becomes a film 61 containing a predetermined content of the solvent in the tenter dryer 60. Then the film 61 is transported into an edge slitting device 62 for slitting off both edge portions of the film 61. The slit edge portions are conveyed to a crusher 63 with use of a cutter blower (not shown). The crusher 63 crushes the both edge portions into tips, which are reused for preparation of the dope in view of the cost. Note that the slitting off the both edge portions of the film may be omitted. However, it is preferable to slit them off somewhere between the casting of the dope and the winding the film.

The film 61 is transported into a drying chamber 65 in which there are plural rollers 64. The temperature in the drying chamber 65 is not restricted especially, and preferably in the range of 50° C. to 200° C. The drying of the film 61 in the drying chamber 65 is made with wrapping around the rollers 64 so as to evaporate the solvent. The drying chamber 65 is provided with an adsorbing device 66 for adsorbing and recovering the solvent vapor. The air from which the solvent vapor is removed is sent as the drying air again. Note that the drying chamber 65 is preferably partitioned into plural partitions so as to vary the drying temperature. Further, it is preferable to provide a pre-drying chamber between the edge slitting device 62 and the drying chamber 65 so as to make the pre-drying of the film 61. In this case, the deformation of the film which is caused by the accelerate increase of the temperature of the film is prevented.

The film 61 is transported into a cooling chamber 67, and cooled to a room temperature. Note that a moisture control chamber (not shown) may be provided between the drying chamber 65 and the cooling chamber 67. In the moisture control chamber, an air whose moisture and temperature are controlled is fed toward the film 61. Thus the winding defect of the film is prevented when the film 61 is wound.

It is preferable to provide a compulsory neutralization device (neutralization bar) 68 such that the charged voltage may be in the range of −3 kV to +3 kV in transporting the film 61. In FIG. 1, the neutralization device 68 is disposed in a downstream side from the cooling chamber 67. However, the position of the neutralization device 68 is not restricted in this figure. Further, it is preferable to provide a knurling roller 96 for providing a knurling with an embossing processing. Note that the unevenness in the area in which the knurling is provided is preferably in the range of 1 μm to 200 μm.

At last, the film 61 is wound around a winding shaft 71 in a winding chamber 70. The winding is preferably made with applying a predetermined tension by a press roller 72, and it is preferable to change the tension from a start to an end of the winding little by little. The length of the film 61 to be wound is preferably at least 100 m, and a width thereof is preferably at least 600 mm, and especially from 1400 mm to 1800 mm. However, even if the width is more than 1800 mm, the present invention is effective. Further, in the present invention, the thickness of the film to be produced is in the range of 15 μm to 100 μm.

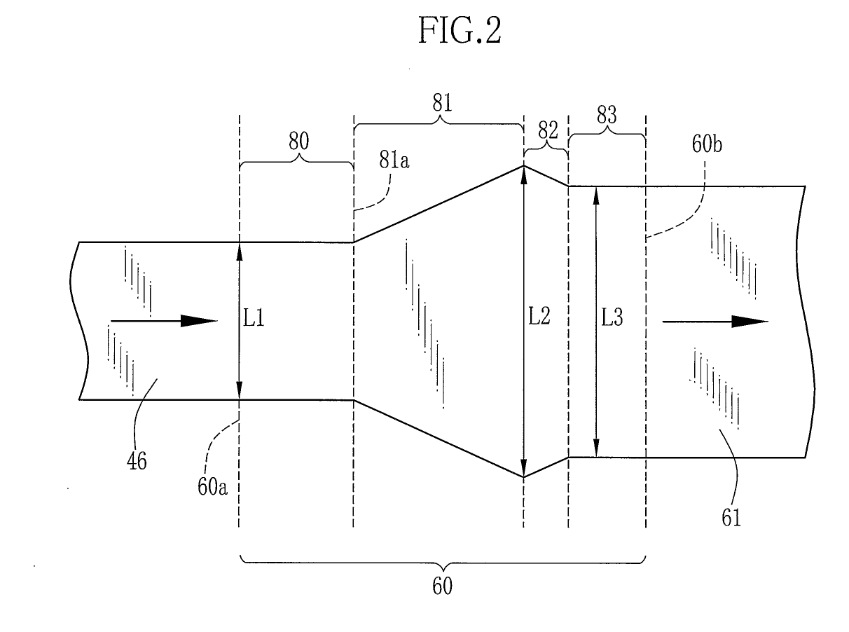

With reference to FIG. 2, stretch and relaxation of the wet film 46 in the tenter drier 60 is explained. The wet film 46 peeled from the belt 33 as the support is transported and dried through the interval section 50, so as to contain a predetermined content of the remaining solvent in which there are mainly organic compounds. Then the wet film 46 is sent to the tenter drier 60. Note that the content of the remaining solvent is not limited, but is preferably in a range of 10 wt. % to 290 wt. %, particularly in a range of 10 wt. % to 120 wt. %, especially in a range of 20 wt. % to 80 wt. % in dry measure basis (weight of the film after the drying is 100 wt. %).

In the tenter drier 60, both edge portions of the wet film 46 are held by holders (for example clips). Thus the width between tracks of the holders is changed so as to make the stretch and relaxation. The wet film 46 is held by the clips (not shown) at an entrance 60a. The temter device 60 has four sections depending on track separation. The four sections are constituted of an entrance section 80 for preheating and drying the wet film 46, in which the tracks of the holders are substantially uniform, a stretching section 81 for enlarging a film width, a relaxation section 82 for reducing a film width, and an exit section 83 in which the film thickness after the relaxation is substantially uniform. At an exit 60b in the exit section 83, the film is released from the clips and fed out from the tenter dryer 60.

The substantial uniformity of the film width at the entrance section 80 and the exit section 83 means that the difference of the film width between the start and the end of each section is equal to or less than ±2%. Since the wet film 46 contains the remaining solvent, the drying of the organic solvent is continuously made from the entrance section 80 to the exit section 83. Several sorts of methods of drying the device for drying the organic solvent can be applied to the present invention. However, the method of drying with feeding a hot air to the wet film 46 is especially preferable in view of the cost for the equipment.

A temperature for drying the wet film 46 (hereinafter the drying temperature) is preferably same along the width direction of the wet film 46. Accordingly, the content of the solvent in the width direction of the wet film 46 becomes approximately even, so that partial contraction or the like in the wet film 46 is prevented. The drying temperature is not limited, but is preferably in a range of 50° C. to 180° C. When the drying temperature is below 50° C., the volatilization of the organic solvent from the wet film 46 becomes too slow, which reduces the productivity of the film 61. When the drying temperature is over 180° C., there becomes possibility that bumping of the contained organic solvent near the surface of the wet film 46 is caused, which deteriorates the smoothness of the surface of the film.

In the present invention, to control the axial misalignment of the slow axis to the widthwise direction of the film, conditions of the stretch and relaxation of the wet film 46 are adjusted.

As shown in FIG. 2, the both edge portions of the wet film 46 are held by the clips (not shown) at the entrance 60a. The width between tracks of the clips (approximately equal to the width of the wet film) is L1 (mm) at the entrance 60a. The plural clips are connected to a chain. The chain is meshed with a sprocket to be moved endlessly. By movement of the chains, the clips moves to the stretching section 81, where the width between tracks of the clips is gradually increased. The maximal width of tracks of the clips in the stretching section 81 is L2 (mm). After the stretching, the width of the wet film 46 is reduced in the relaxation section 82. The width between tracks of the clips in the exit section 83 is L3 (mm).

In the present invention, a maximal value of stretch ratio Lₘₐₓ(%) and a stretch ratio after relaxation Lₒᵤₜ(%) are defined as following formulae:

Lₘₐₓ(%)={(L2/L1)−1}×100

Lₒᵤₜ(%)={(L3/L1)−1}×100

In addition, a relaxation ratio L(%) is defined as a following formula:

L(%)=Lₘₐₓ−Lₒᵤₜ

By transforming this formula to include L1 to L3, it becomes a following formula:

L={(L2−L3)/L1}×100

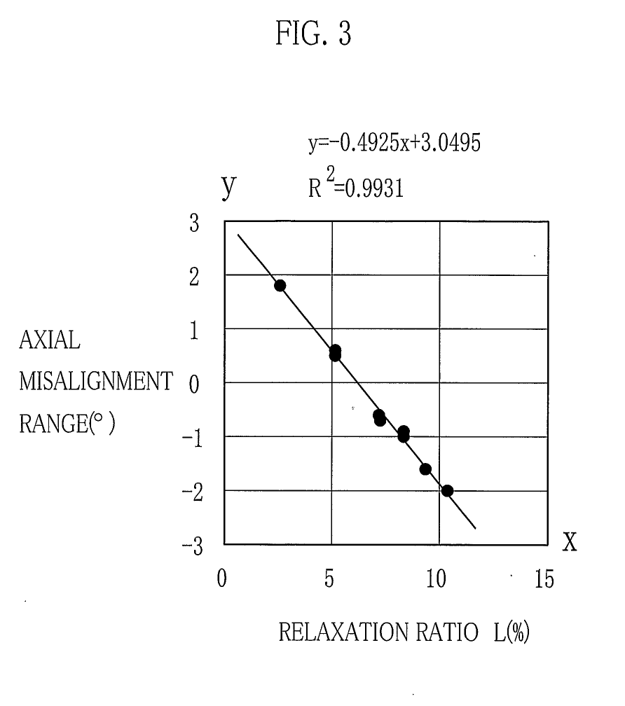

By keen examination, the inventor found that there is a linear relation between the relaxation ratio L(%) and an axial misalignment range (MAX-MIN). The axial misalignment range is a difference between a maximum axial misalignment and a minimum axial misalignment, when the axial misalignment is measured by each area of 50 mm×50 mm in a sample film having 10 m length in lengthwise direction. Note that the axial misalignment is an angle of the slow axis to the widthwise direction of the film. As shown in FIG. 3, when x-axis was the relaxation ratio L, y-axis was the axial misalignment range and R is correlation coefficient, the relation between them was y=−0.4925x+3.0495 in R²=0.9931. The axial misalignment takes positive value when the slow axis is misaligned from the widthwise direction of the film in forward direction of the casting (conveying), while the axial misalignment takes negative value when the slow axis is misaligned from the widthwise direction of the film in backward direction. FIG. 3 teaches that the axial misalignment by the bowing phenomenon can be quantitatively controlled by adjustment of the relaxation ratio L(%).

In the present invention, the relaxation ratio L (%) is preferably in a range of 3<L<9, particularly in a range of 5<L<7.5. When the relaxation ratio L (%) is not over 3, the axial misalignment by the bowing phenomenon cannot be corrected. When the relaxation ratio L (%) is 9 and over, there becomes possibility to overcorrect the axial misalignment. When the positive axial misalignment is overcorrected (the excess stress is applied to the film), there may be the negative axial misalignment. In addition, when too much relaxation is applied to the film, there becomes possibility to deteriorate the smoothness of the surface of the film.

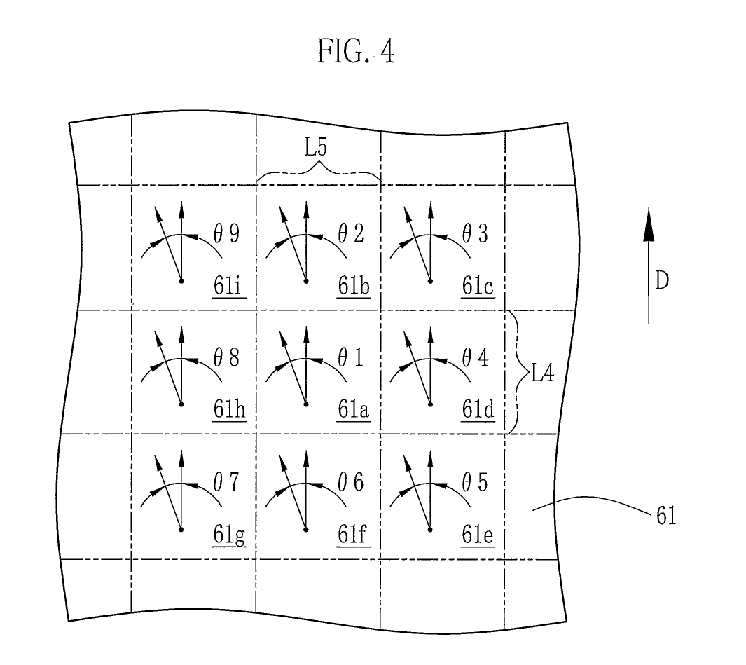

A property of the film 61 produced by the solution casting method of the present invention will be explained with reference to FIG. 4. In FIG. 4, the widthwise direction D of the film 61 is shown by an arrow. An area in the film 61 is arbitrarily determined as a reference area 61a. The reference area 61a has a length in the widthwise direction D which is L4 (mm), and a length in the lengthwise direction which is L5 (mm). In the present invention, although it is preferable that both L4 and L5 have 50 mm length, the lengths are not limited. The axial misalignment θ1 in the reference area 61a is preferably below 2.0°, more preferably below 1.0°.

Areas adjacent to the reference area 61a in the film 61 are determined as adjacent areas 61b to 61i. The each axial misalignment in the respective adjacent areas 61b to 61i is respectively shown as θ2 to θ9. Also in the adjacent areas 61b to 61i, each of θ2 to θ9 is preferably below 2.0°, more preferably below 1.0°. In general, the bowing phenomenon is occurred in the wet film 46 while the solution casting. By the bowing phenomenon, the slow axis of the wet film 46 is bent like an arch toward the forward direction of the conveyance. In considering this problem, in the present invention, the wet film 46 is relaxed to produce a stress in the backward direction of the conveyance. By the stress in the backward direction, the misalignment of the slow axis toward the forward direction can be corrected.

The solution casting method of the present invention may be a co-casting method in which a co-casting of two or more sorts of the dopes are made such that the dopes may form a multi-layer film, or a sequentially casting method in which two or more sorts of the dopes are sequentially cast so as to form the multi-layer film. When the co-casting is performed, a feed block may be attached to the casting die, or a multi-manifold type casting die may be used. A thickness of each upper and lowermost layer of the multi-layer casting film on the support is preferably in the range of 0.5% to 30% to the total thickness of the multi-layer casting film. Furthermore, in the co-casting method, when the dope is cast onto the support, it is preferable that the lower viscosity dopes may entirely cover over the higher viscosity dope. Furthermore, in the co-casing method, it is preferable that the inner dope is covered with dopes whose alcohol contents are larger in the bead from a die to the support.

Note that Japanese patent publication No. 2005-104148 teaches in detail the structure of the casting die, the decompression chamber and the support, drying conditions in each processes (such as the co-casting, the peeling and the stretching), a handling method, a winding method after the correction of planarity and curling, a recovering method of the solvent, a recovering method of film and the like. The description of the above publication may be applied to the present invention.

[Characteristics, Measuring Method]

This publication No. 2005-104148 teaches the characteristics and the measuring method of the cellulose acylate film, which may be applied to the present invention.

[Surface Treatment]

It is preferable to make a surface treatment of at least one surface of the cellulose acylate film. Preferably, the surface treatment is at least one of glow discharge treatment, atmospheric pressure plasma discharge treatment, UV radiation treatment, corona discharge treatment, flame treatment, and acid or alkali treatment.

[Functional Layer]

A primary coating may be made over at least one surface of the cellulose acylate film. Further, it is preferable to provide other functional layers for the cellulose acylate film as a film base so as to obtain a functional material. The functional layers may be at least one of antistatic agent, cured resin layer, antireflection layer, adhesive layer for easy adhesion, antiglare layer and an optical compensation layer.

Preferably, the functional layer contains at least one sort of surface active agent in the range of 0.1 mg/m² to 1000 mg/m². Further, preferably, the functional layer contains at least one sort of lubricant in the range of 0.1 mg/m² to 1000 mg/m². Further, preferably, the functional layer contains at least one sort of matting agent in the range of 0.1 mg/m² to 1000 mg/m². Further, preferably, the functional layer contains at least one sort of antistatic agent in the range of 1 mg/m² to 1000 mg/m². Conditions and methods of performing a surface treatment and providing a functional layer with several functions and characteristics are described in Japanese patent publication No. 2005-104148.

The cellulose acylate film can be used as the protective film in a polarizing filter. To obtain a LCD, two polarizing filters, in each of which the cellulose acylate film is adhered to polarizer, are disposed so as to sandwich a liquid crystal layer. The publication No. 2005-104148 discloses TN type, STN type, VA type, OCB type, reflection type, and other example in detail. To these types can be applied the film of the present invention. Further, the application teaches the cellulose acylate film provided with an optical anisotropic layer and that provided with antireflective and antiglare functions. Furthermore, the application supposes to provide the cellulose acylate film with adequate optical functions, and thus a biaxial cellulose acylate film is obtained and used as the optical compensation film, which can be used as the protective film in the polarizing filter simultaneously. The restriction thereof described in the publication No. 2005-104148 can be applied to the present invention.

In addition, a polymer film having superior optical characteristics can be obtained according to the present invention. The present invention is especially effective to a cellulose triacetate film (TAC film). The TAC film can be used as a base film of a photosensitive material or a protective film in a polarizing filter. The TAC film is also used as an optical compensation film for widening a view angle of a liquid crystal display used for a TV monitor. In this case, preferably the TAC film also has the function of the protective film in the polarizing filter. Accordingly, the TAC film can be used for an IPS (In-Plane Switching) mode, an OCB (Optionally Compensatory Bend) mode, a VA (Vertically Aligned) mode and the like as well as for a conventional TN (Twisted Nematic) mode.

### EXAMPLE

Example of the present invention was explained. However, the present invention was not restricted in the example. In this example, Experiments 1-21 were performed. The explanation of Experiment 1 of the present invention was made in detail, and the same explanations of Experiments 2-17 of the preset invention and Experiments 18-21 as comparisons were omitted. Further, the conditions and the results of the examinations were respectively shown in Table 1&2.

(Preparation of Primary Dope)

| | |
|---|---|
| cellulose triacetate | 89.3 wt. % |
| (degree of substitution, 2.8) | |
| Triphenylphosphate | 7.1 wt. % |
| Biphenyldiphenylphosphate | 3.6 wt. % |

To these solid materials, a mixture solvent of following compounds was added:

| | |
|---|---|
| Dichloromethane | 87 wt. % |
| Methanol | 13 wt. % |

The mixture of the solid materials and the mixture solvent was stirred to make the dissolution so as to obtain the primary dope 16, in which the content of the solid materials was 19.0 wt. %. Then the filtration of the prepared dope was made.

(Preparation of First Additive Liquid)

For preparation of the first additive liquid, following compounds are used:

| | |
|---|---|
| Compound of Chemical Formula 57 | 20.0 wt. % |
| Primary Dope | 13.9 wt. % |

The compounds of Chemical Formula 57 was N,N′-di-m-tolyl-N″-p-methoxyphenyl-1,3,5-triazine-2,4,6-triamine, whose structure is shown in following:

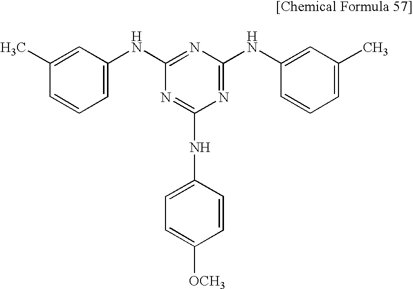

Note that to 100 wt. % of the TAC, 5.55PHR of the compounds of Chemical Formula 57 was added.

(Preparation of Second Additive Liquid)

| | |
|---|---|
| Silica Particles | 2.0 wt. % |
| (R972 produced by Nippon Aerozil Co., Ltd.) | |
| Primary Dope | 15.6 wt. % |
| Dichloro Methane | 76.1 wt. % |
| Methanol | 11.3 wt. % |

The mixture of the above compounds was mixed and dissolved by an attritor to prepare the second additive liquid 14.

Then the second additive liquid 14 was mixed with the first additive liquid 12 with use of the static mixer 20, and further a mixture of the first additive liquid 12 and the second additive liquid 14 (adding liquid) was mixed by the static mixer 21.

The casting die 30 to be used was 1.8 m in width. The casting was made with regulating a flow rate of the dope from the casting die 30, such that the thickness of the produced film might be 80 ?m and the width of the casting might be 1700 mm. In order to regulate the temperature of the dope to 36° C., a jacket (not shown) is provided with the casting die, and a heat transfer medium (water) whose temperature was controlled to 36° C. at an entrance of the jacket was fed into the jacket.

At producing the film, the temperatures of the casting die 30 and pipes are kept to 36° C. Further, the casting die 30 was coathanger type, in which bolts for adjusting the thickness of the film are provided with pitch of 20 mm. Then the adjustment was made with use of the bolts. Thus, in the film except of the 20 mm edge portions, the difference of the thickness at any two points apart at 50 mm was at most 1 μm, and further the difference of the minimal thickness value and the maximal thickness value in the widthwise direction was at most 3 μm. The variation of the film thickness was in the range of ±1.5% to the predetermined film thickness.

In a primary side from the casting die 30, the decompression chamber 40 was disposed, whose decompression rate can be adjustable depending on the casting speed, such that there would be a pressure difference in the range of 1 Pa to 5000 Pa between up- and downstream sides. Further, the temperature of the decompression chamber was also regulated. there was labyrinth packing (not shown) in front and rear sides of the bead. Further, there were openings in both sides. Further, in order to compensate the disorder of the both edges of the casting beads, an edge suctioning device (not shown) was used.

The material of the casting die 30 was a precipitation hardened stainless or a stainless having double-phase structure. The material had coefficient of thermal expansion of at most 2×10⁻⁵ (° C.⁻¹), the almost same anti-corrosion properties as SUS316 in examination of corrosion in electrolyte aqua solution. Further, when the material was dipped in a mixture liquid of dichloromethane, methanol and water, pitting (holes) were not formed on the gas-liquid interface. The surface roughness Ry of a contacting surface of the casting die 30 to the dope was at most 1 μm, a straightness was at most 1 μm/m in each direction, and the clearance of the slit was automatically controlled in the range of 0.5 mm to 3.5 mm. In this embodiment, the slit clearance was 1.5 mm. An end of the contacting portion of each lip to the dope was processed so as to have a chamfered radius at most 50 μm through the slit. In the die, the shearing speed was in the range of 1(1/sec) to 5000(1/sec).

Further, lip ends are provided with a hardened layer. In order to provide the hardened layer, there are methods of ceramic coating, hard chrome plating, nitriding treatment and the like. If the ceramics is used as the hardened layer, the grind was possible, the porosity becomes lower, and was not friable and the good corrosion resistance. Further, as the preferable ceramics, there was no adhesive property to the dope. Concretely, as the ceramics, there are tungsten carbide, Al₂O₃, TiN, Cr₂O₃ and the like, and especially tungsten carbide. Note in the present invention the hardened layer was formed by a tungsten carbidecoating in a spraying method.

On the both edges of a die slit, the discharged dope is partially dried to be a solid. In order to prevent the solidification of the dope, a mixture solvent (87 pct.wt of dichloro methane and 13 pts.wt of acetone) to which the dope was dissoluble was supplied at 0.5 ml/min to each bead edge and the air-liquid interface of the slit. The pump for supplying the dope has a pulsation at most 5%. Further, the pressure in the rear side (or the upstream side) of the bead was decreased by 150 Pa. Further, in order to make the temperature in the decompression chamber 40 constant, a jacket (not shown) was provided. Into the jacket, a heat transfer medium whose temperature was regulated to 40° C. was fed. The airflow of the edge suctioning was in the range of 1 L/min to 100 L/min, and in this embodiment, the air flow rate was regulated in the range of 30 L/min to 40 L/min.

The belt 33 was a stainless endless belt that was 2.0 m in width and 70 m in length. The thickness of the belt 33 was 1.5 mm and the polishment was made such that a surface roughness Ry was at most 0.05 μm. The material was SUS 316 and had enough corrosion resistance and strength. The thickness unevenness of the belt 33 was at most 0.5%. The belt 33 was rotated by drive of two rollers 31, 32. At this time, a tension of the belt 33 was 1.0×10⁴ kg/m, and the difference of the relative speed of the rollers 31, 32 and the belt 33 was at most 0.01 m/min. Further, the velocity fluctuation of the belt 33 was at most 0.5%. The rotation was regulated with detecting the positions of both edges such that the film meandering in widthwise direction for one rotation might be regulated to at most 1.5 mm. Further, the positional fluctuation in horizontal directions of the lips and the belt 33 just below the casting die 30 was at most 200 μm.

Into the rollers 31, 32 are fed the heat transfer medium so as to perform the temperature regulation of the belt 33. Into the roller 31 in a side of the casting die 30 was fed the heat transfer medium (water) at 20° C. and into the roller 32 was fed the heat transfer medium (water) at 40° C. The surface temperature of the middle portion of the belt 33 just before the casting was 15° C., and the temperature difference between both side edges was at most 6° C. Note that the belt 33 preferably had no defect on surface, and especially preferably, the number of pinholes whose diameter was at least 30 μm was zero, that of the pinholes whose diameter was from 10 μm to 30 μm was 1 per 1 m², and that of the pinholes whose diameter was less than 10 μm was 2 per 1 m².

The temperature of the casting chamber 35 was kept to 35° C. The dope 33 is cast onto the belt 33 to form the casting film 39, to which the drying air of parallel flow to the casting film 39 was fed at first to dry. Airs were fed from the air blowers 41-43 such that the temperature of the drying air might be 135° C. in an upper and upstream side, 140° C. in an upper and downstream side, and 65° C. in a lower side. The saturated temperature of each drying wind was about −3° C. Then the wet film 46 was peeled from the belt 33. In order to reduce the peeling defect, the peeling speed to the moving speed of the belt was 100.5%. The solvent vapor generated by the drying was condensed by the condenser 37 and then recovered by the recovery device 38. The drying air from which the solvent vapor was removed was heated again and reused as the drying air. The wet film 46 was transported in the interval portion 50 with use of five rollers toward the tenter dryer 60. At the same time, the water content in the solvent was regulated to at most 0.5% to reuse the solvent. During the transporting in the interval portion 50, the drying air at 70° C. was fed from the air blower 51 so as to further dry out the wet film 46.

The wet film 46 transported into the tenter dryer 60 was further transported in the entrance section 80 without changing the width (see, FIG. 2). The content of the remaining solvent at the stretch start position 81a was 38.0 wt. %. The width L1 at the entrance 60a was 1465 mm. After stretching the wet film 46 in the stretching section 81, the maximum width L2 became 1841 mm. The drawing speed was 0.8%/min. Then the wet film 46 was relaxed in the relaxation section 82, such that the width L3 in the exit section 83 became 1765 mm. The relaxation speed was 0.7%/min. The content difference of the remaining solvent (dry measure basis) was 18.0 wt. %. In this case, the maximal value of stretch ratio Lₘₐₓ(%) was 25.7%, the stretch ratio after relaxation Lₒᵤₜ(%) was 20.5%, and the relaxation ratio L(%) was 5.2%.

After the transport in the exit section 83 with keeping the width, the wet film 48 was fed out as the film 61 from the tenter dryer 60. In the tenter dryer 60, the heating air of 140° C. was controlled such that a wind speed in the widthwise direction might be constant, and fed out into a normal direction of the film through nozzles (not shown) intermittently disposed.

Then, the edge slitting of both edge portions was made in 30 seconds after exit from an exit 60b of the tenter dryer 60. Before drying at the high temperature in the drying chamber 66 which will be explained later, the preheating of the film 61 was made in a predrying room (not shown) into which the drying air at 100° C. was fed.

The film 61 was dried at high temperature in the drying chamber 65. In a former part of the drying chamber 65, the hot air at 120° C. was supplied, and in a latter part, the hot air at 130° C. was supplied. Thereafter, the unnecessary side edge portions were trimmed. Note that the tension of transporting the film 61 by the roller 64 in the drying chamber was 100N/width, and the drying was made for about 30 minutes such that the content of the remaining solvent might be less than 0.2 wt. %. The material of the roller 64 was aluminum or carbon steel, and a hard chrome coating was made on a surface or periphery. Two types of the rollers 64 were used. In the first type, the surface of the roller 64 was flat, and in the second type, the blasting was made for the matting process on the surface. The positional fluctuation (or eccentricity) in the rotation of the roller 64 was at most 50 μm, and the bending of the roller 64 at the tension of 100N/width was 0.5 mm.

In the solution casting method, the peeled polymer film before wound up is applied various processes including the drying process and the process of cutting side edge portions of the film. While being applied these processes, the polymer film is supported and fed by rollers. As the rollers, there are drive rollers and non-drive rollers. The non-drive roller is used for determining a feeding path of the polymer film and increasing a stability of feeding.

The drive roller is used for transmitting the driving force to the polymer film so as to feed it downstream. As the drive roller, a suction roller is usually used. While feeding of the film, different film tensions may be required in the different processes, such as the casting process, the peeling process, the drying process and the winding process. In this case, the suction roller applies the driving force to the film so as to change the film tension. The suction roller has a plurality of suction holes on a contact surface thereof so as to suck the polymer film thereon while the feeding.

When the suction roller is used for feeding the film, since a complex power whose direction cannot identify acts on the film, the film is likely to be deformed. Further, the film can be deformed by the difference of the film tensions between upstream and downstream from the suction roller. In addition, when the polymer film slips, contracts or becomes deformed while contacting on edges of the suction holes, microscopic flaws are occurred on the film.

The drive roller used in the feeding has a hardened surface. The hardening may be performed by hard chrome plating, nitridation, quenching or the like. The degree of hardness is in a range of 500 to 2000, preferably in a range of 800 to 1200 in Vickers hardness.

The drive roller is a suction roller having a plurality of suction holes on its surface. The surface roughness Ry of the roller surface is preferably in a range of 0.3 μm to 1.0 μm, particularly in a range of 0.5 μm to 0.8 μm. The value of the surface roughness Ry is measured in area of the roller surface without the suction hole. A diameter of the suction hole is preferably in a range of 1 mm to 6 mm, particularly in a range of 2 mm to 4 mm. A width of chamfer of the suction hole is preferably in a range of 2% to 20% in ratio to the diameter thereof.

While the suction roller is driven, it is preferable that a surface temperature thereof is controlled. For this purpose, at least one roller temperature controller, which corresponds to the single suction roller, is preferably provided. It is preferable that the roller temperature controller controls the surface temperature of the suction roller so as to be higher than temperature of the film immediately before contacting to the suction roller. Note that Japanese Patent Application No. 2004-160159 teaches in detail the structure of the suction roller. The description of the above publication may be applied to the present invention.

The solvent vapor in the drying air was removed by the adsorbing device 66. The adsorptive agent was activated carbon, and the desorption was made with the dried air. Thus the water content of the recovered solvent was made at most 0.3 wt. %, and thereafter the recovered solvent was used for the solvent for preparing the dope. The drying air includes not only the solvent vapor but also other compounds such as plasticizer, UV-absorbing agent and compounds of high boiling points. Therefore the other compounds are removed with cooling by cooling device and a preadsorber, and recycled. Then the adsorption and desorption conditions were set such that VOC (volatile organic compounds) in the exhaust gas might become at most loppm. Both edge portions were slit off and then knurling of the both sides of the film 61 was made by a knurling roller 69. The knurling was performed by embossing process from a side. The pressure of the knurling was regulated, such that averaged width of the knurling might be 10 mm, and the maximal height might be 12 μm larger than the averaged thickness.

Thereafter, the film 61 was transported into the winding chamber 70 in which the temperature was 28° C. and the humidity was 70%. Further, an ionizer (not shown) was disposed in the winding chamber 70 such that the charged voltage might be in the range of −1.5 kV to +1.5 kV. Thus the film 61 was obtained to have the thickness of 80 μm and the width of 1340 mm. The diameter of the winding shaft 71 was 169 mm. The tension was 250 N/width in the beginning of winding and 220 N/width in the end of winding. The total length of the wound-up film was 2640 m. The meander period was 400 m, and the oscillation range was +5 mm. In the winding, the temperature of the film was 25° C., and the water content was 1.4 wt, %, the content of the remaining solvent was less than 0.2 wt. %. The content of the silica particles was 0.13 wt. %.

The samples 61a were obtained at the positions 50 mm apart from the both edges of the produced film and at a center of the produced film, with use of a cutting plotter. Then an angle of the slow axis to the lengthwise direction of the film and a Re value in luminance at 632.8 nm were measured with use of KOBRA-21DH (produced by Oji Scientific Instrument). For example, in Experiment 1, the average of the measured Re value was 38.4 nm. Among the three samples, a maximum angle of the slow axis to the lengthwise direction of the film was 90.5°, and a minimum angle of the slow axis to the lengthwise direction of the film was 90°. Accordingly, the axial misalignment range was 0.5°. When the samples 61b to 61i adjacent to the each sample 61a were cut off to measure an average angle of the slow axis to the lengthwise direction of the film, the average angle was 90.4°. The direction of the bowing was measured at the measurement angle for the axial misalignment.

TABLE 1

| | L1 | L2 | L3 | CF57 | Lₘₐₓ | Lₒᵤₜ | L |
|---|---|---|---|---|---|---|---|
| | (mm) | (mm) | (mm) | (PHR) | (%) | (%) | (%) |
| Ex. 1 | 1465 | 1841 | 1765 | 5.55 | 25.7 | 20.5 | 5.2 |
| Ex. 2 | 1478 | 1803 | 1765 | 5.13 | 22.0 | 19.4 | 2.6 |
| Ex. 3 | 1478 | 1841 | 1765 | 5.13 | 24.6 | 19.4 | 5.1 |
| Ex. 4 | 1478 | 1871 | 1765 | 5.13 | 26.6 | 19.4 | 7.2 |
| Ex. 5 | 1478 | 1888 | 1765 | 5.13 | 27.7 | 19.4 | 8.3 |
| Ex. 6 | 1478 | 1903 | 1765 | 5.13 | 28.7 | 19.4 | 9.3 |
| Ex. 7 | 1478 | 1918 | 1765 | 5.13 | 29.7 | 19.4 | 10.3 |
| Ex. 8 | 1478 | 1918 | 1780 | 5.13 | 29.7 | 20.4 | 9.3 |
| Ex. 9 | 1478 | 1918 | 1795 | 5.13 | 29.7 | 21.4 | 8.3 |
| Ex. 10 | 1478 | 1918 | 1811 | 5.13 | 29.7 | 22.5 | 7.2 |
| Ex. 11 | 1469 | 1947 | 1849 | 2.88 | 32.5 | 25.9 | 6.7 |
| Ex. 12 | 1476 | 1871 | 1789 | 3.10 | 26.8 | 21.2 | 5.6 |
| Ex. 13 | 1476 | 1888 | 1802 | 3.10 | 27.9 | 22.1 | 5.8 |
| Ex. 14 | 1475 | 1903 | 1814 | 3.10 | 29.0 | 23.0 | 6.0 |
| Ex. 15 | 1475 | 1918 | 1826 | 3.10 | 30.0 | 23.8 | 6.2 |
| Ex. 16 | 1475 | 1932 | 1838 | 3.10 | 31.0 | 24.6 | 6.4 |
| Ex. 17 | 1475 | 1947 | 1849 | 3.10 | 32.0 | 25.4 | 6.6 |
| Ex. 18 | 1465 | 1841 | 1830 | 2.88 | 25.7 | 24.9 | 0.8 |
| Ex. 19 | 1465 | 1947 | 1937 | 2.88 | 32.9 | 32.2 | 0.7 |
| Ex. 20 | 1465 | 1841 | 1620 | 2.88 | 25.7 | 10.6 | 15.1 |
| Ex. 21 | 1465 | 1947 | 1725 | 2.88 | 32.9 | 17.7 | 15.2 |

L1: width between tracks of the clips at the entrance 60a of the tenter dryer 60
L2: maximal width of tracks of the clips in the tenter dryer 60
L3: width between tracks of the clips in the exit section 83
CF57: additive rate of compound of Chemical Formula 57
Lₘₐₓ: maximal value of stretch ratio
Lₒᵤₜ: stretch ratio after relaxation
L: relaxation ratio

TABLE 2

| | Re | Aₘᵢₙ | Aₘₐₓ | MR | Aₐᵥₑ | |
|---|---|---|---|---|---|---|
| | (nm) | (°) | (°) | (°) | (°) | Bowing |
| Ex. 1 | 38.4 | 90 | 90.5 | 0.5 | 90.4 | E |
| Ex. 2 | 38.1 | 89.6 | 91.4 | 1.8 | 90.5 | B_{f} |
| Ex. 3 | 38.2 | 90.6 | 91.2 | 0.6 | 90.9 | E |
| Ex. 4 | 37.2 | 90.3 | 90.9 | 0.6 | 90.7 | E |
| Ex. 5 | 36.7 | 90.1 | 91.1 | 1 | 90.7 | B_{b} |
| Ex. 6 | 36.1 | 90 | 91.6 | 1.6 | 90.8 | B_{b} |
| Ex. 7 | 35.5 | 89.6 | 91.6 | 1.9 | 90.8 | B_{b} |
| Ex. 8 | 38.1 | 89.6 | 91.2 | 1.6 | 90.2 | B_{b} |
| Ex. 9 | 40.6 | 90 | 90.9 | 1.1 | 90.4 | B_{b} |
| Ex. 10 | 43.3 | 90.2 | 90.9 | 0.7 | 90.5 | E |
| Ex. 11 | 33.9 | 89.9 | 90.6 | 0.7 | 90.3 | E |
| Ex. 12 | 30.4 | 88.8 | 89.7 | 0.9 | 90.2 | E |
| Ex. 13 | 31.7 | 89.5 | 90.4 | 0.9 | 90 | E |
| Ex. 14 | 32.7 | 89.1 | 90.3 | 0.8 | 89.7 | E |
| Ex. 15 | 33.9 | 89 | 90.6 | 0.9 | 89.7 | E |
| Ex. 16 | 34.4 | 90.1 | 90.9 | 0.8 | 90.5 | E |
| Ex. 17 | 35.4 | 89 | 90.2 | 0.8 | 89.7 | E |
| Ex. 18 | 35.0 | 88.9 | 91.9 | 3 | 90.4 | N_{f} |
| Ex. 19 | 42.3 | 88.6 | 91.9 | 3.3 | 89.9 | N_{f} |
| Ex. 20 | 13.3 | 87.9 | 90.8 | 2.9 | 90.1 | N_{b} |
| Ex. 21 | 20.3 | 87.6 | 91.1 | 3.5 | 89.1 | N_{b} |

Aₘᵢₙ: minimum angle of the slow axis to the lengthwise direction
Aₘₐₓ: maximum angle of the slow axis to the lengthwise direction
MR: axial misalignment range
Aₐᵥₑ: average angle of the slow axis to the lengthwise direction Estimation of Bowing:
E; excellent in optical isotropy
B_{f}; forward bowing having no influences on practical use
B_{b}; backward bowing having no influences on practical use
N_{f}; forward bowing inadequate for optical use
N_{b}; backward bowing inadequate for optical use

From results of Experiments shown in Table 1 and Table 2, it was found that the bowing phenomenon was decreased when the relaxation ratio L was under the condition of 3<L<9. In this condition, the polymer film having superior optical isotropy can be obtained. In addition, it was found that when the relaxation ratio L was under the condition of 5<L<7.5, the generation of the bowing was substantially prevented.

After the saponification of the film produced in Experiment 1 as an example of the present invention, the film was adhered to a surface of a polarized film, and FUJITAC produced by Fuji Photo Film Co., Ltd. (trade name; 80 μm) was adhered to another surface of the polarized film. Thus a polarizing filter was obtained, and used instead of the retardation film and the polarizing filter of VA-type (vertical alignment type) liquid crystal display. Then the image was displayed in a good condition.

Various changes and modifications are possible in the present invention and may be understood to be within the present invention.

### INDUSTRIAL APPLICABILITY

The present invention is preferably applied to devices for requiring high retardation value of the polymer film, especially to devices associated to liquid crystals.

1. A polymer film produced by casting a dope containing a polymer and a solvent onto a support, drying said dope, peeling said dope as a film, enlarging a width of said film by stretching said film, and performing a relaxation such that said width becomes shorter by a predetermined value,
wherein a misalignment of a slow axis from a widthwise direction of said film was less than 2.00 at any position on said film.

2. A polymer film described in claim 1, wherein said stretching and relaxation were performed with holding both side edge portions of said film by a holding device.

3. A polymer film described in claim 1, wherein when a width of said film right before said stretching was L1 (mm), a maximum width of said film in said stretching was L2 (mm) and a width of said film right after said relaxation was L3 (mm), said stretching and relaxation were performed so as to satisfy a following formula,
3<(L2−L3)/L1×100<9

4. A polymer film described in claim 1, wherein a temperature for heating said film was almost constant during said stretch and relaxation.

5. A polymer film described in claim 4, wherein said temperature for heating said film was in a range of 50° C. to 180° C. during said stretch and relaxation.

6. A polymer film described in claim 1, wherein said polymer film is an optical film.

7. A polymer film described in claim 1, wherein said polymer film is a cellulose ester film.

8. A solution casting method comprising steps of:
casting a dope onto a support, said dope containing a polymer and a solvent;
drying said dope;
peeling said dope as a film;
enlarging a width of said film by stretching said film with holding both side edge portions of said film by a holding device;
performing a relaxation with continuing the holding, such that said width becomes shorter by a predetermined value; and
wherein when a width of said film right before said stretching is L1 (mm), a maximum width of said film in said stretching is L2 (mm) and a width of said film right after said relaxation is L3 (mm), said stretching and relaxation are performed so as to satisfy a following formula,
3<(L2−L3)/L1×100<9

9. A solution casting method described in claim 8, wherein a temperature for heating said film is almost constant during said stretching and relaxation.

10. A solution casting method described in claim 8, wherein said temperature for heating said film is in a range of 50° C. to 180° C. during said stretching and relaxation.

11. A solution casting method described in claim 8, wherein a misalignment of a slow axis of said film from a widthwise direction of said film is less than 2.0° at any position on said film.

12. A solution casting method described in claim 8, wherein said polymer is cellulose ester.
